(19) United States
(12) Patent Application Publication
(10) Pub. No.: US 2025/0131789 A1
(43) Pub. Date: Apr. 24, 2025

(54) MODULAR FRAME FOR LOTTERY TICKET DISPENSER

(71) Applicant: Schafer Systems (2018), Inc., Adair, IA (US)

(72) Inventor: Paul Shardlow, Manchester (GB)

(21) Appl. No.: 18/672,814

(22) Filed: May 23, 2024

Related U.S. Application Data
(60) Provisional application No. 63/578,779, filed on Aug. 25, 2023.

(51) Int. Cl. G07F 17/32

(52) U.S. Cl. CPC G07F 17/3216; G07F 17/329

(57) ABSTRACT

Disclosed is a modular frame for a plurality of lottery ticket dispensers. In one nonlimiting example embodiment the modular frame includes a top above the plurality of lottery ticket dispensers, a bottom below the plurality of lottery ticket dispensers, a first side on a first side of the plurality of lottery ticket dispensers, and a second side on a second side of the plurality of lottery ticket dispensers. In at least one nonlimiting example embodiment the top, bottom, first side and second side of the modular frame form a rectangular ring around the plurality of lottery ticket dispensers and the top and bottom include lights to illuminate the plurality of lottery ticket dispensers.

### CROSS-REFERENCE TO RELATED APPLICATIONS

This application claims the benefit of U.S. Provisional Patent Application No. 63/578,779 filed with the United States Patent and Trademark Office on Aug. 25, 2023, the entire contents of which are herein incorporated by reference.

### BACKGROUND

### 1. Field

Example embodiments relate to a modular frame that surrounds lottery ticket dispensers and with an added security frame to protect the dispensers.

### 2. Description of the Related Art

Many lottery ticket dispensers are interconnected with one another. Interconnected lottery ticket dispensers have the advantage of storing large amounts of tickets for consumers.

U.S. Pat. No. 9,150,329, titled “Lottery Ticket Dispenser,” describes a lottery ticket dispenser having features allowing lottery ticket dispensers to be stacked and interlocked with one another. In a nonlimiting example embodiment, the lottery ticket dispensers resemble a box like structure having a roof, a floor, two side walls, a front wall, and a door to allow or prevent access to an inside of the lottery ticket dispensers. The lottery ticket dispensers, in one embodiment, additionally include members allowing the lottery ticket dispensers to connect to one another. For example, in one nonlimiting example embodiment the lottery ticket dispensers include feet, a J-shaped hook, receiving areas and a connecting bar to facilitate connecting one lottery ticket dispenser to another lottery ticket dispenser. For example, in one nonlimiting example embodiment, the feet may be arranged under the floor and towards the back of the lottery ticket dispenser, the J-shaped hook may be arranged under the floor and towards the front of the lottery ticket dispenser. The connection bar may be arranged on or in the roof near the front of the lottery ticket dispenser. The receiving areas may be arranged or formed in the roof near the back of the lottery ticket dispenser. The lottery ticket dispensers having these features may be connected together by moving a first lottery ticket dispenser over a second lottery ticket dispenser, engaging the hook of the first lottery ticket dispenser with the connecting bar of the second lottery ticket dispenser, and rotating the first lottery ticket until the bottom of the first lottery ticket dispenser is over the roof of the second lottery ticket dispenser and the feet of the first lottery ticket dispenser are in the receiving areas of the second lottery ticket dispenser. A complete explanation of this nonlimiting example embodiment is provided in U.S. Pat. No. 9,150,329, the entire contents of which is herein incorporated by reference.

U.S. Pat. No. 7,717,256, titled “Side-by-Side Locking Display and Dispensing Structure,” describes a structure formed by connecting together two substantially identical lottery ticket dispensers via a coupling plate. Like the previously described lottery ticket dispenser, the exemplary lottery ticket dispensers of U.S. Pat. No. 7,717,256 resemble a box like structure having a roof, a floor, two side walls, a front wall, and a door allowing or preventing access to an inside of the lottery ticket dispensers. As shown in U.S. Pat. No. 7,717,256, sides of the lottery ticket dispensers may include a recessed channel, ledges, and slots allowing a coupling plate to connect thereto to facilitate attaching one lottery ticket dispenser to another identical lottery ticket dispenser to form an interconnected structure. It is understood by those skilled in the art that although only two dispensing units are generally shown in the figures of U.S. Pat. No. 7,717,256, through the use of a plurality of the coupling plates, the dispensing structure could be formed with many more of the dispensing units. For purpose of clarity, the entire contents of U.S. Pat. No. 7,717,256 is herein incorporated by reference.

U.S. Pat. No. 5,111,939, titled “Self-Supporting Stacked Display and Dispenser Structure,” describes a stacked structure made up of a plurality of identical box-like units arranged one atop the other in a near vertical array in which each unit presents a front face angled to the vertical in such fashion that the front face of each unit forms a dihedral angle with its next lower and next upper unit. Each unit has a floor and a roof that diverge rearwardly relative to each other which causes each upward unit, resting via its floor on the roof of the next lower unit, to tilt forwardly so that its front face is at a lesser angle to the vertical than the angle between the front face of the next lower unit and the vertical. The configuration is such that the increments by which the angles decrease from bottom to top are equal. For purpose of clarity, the entire contents of U.S. Pat. No. 5,111,939 is herein incorporated by reference

### SUMMARY

The inventor has noticed that while interconnected lottery ticket dispensers efficiently store multiple types and quantities of tickets, these ticket dispensers often go unnoticed by the public. Further, these dispensers are often prone to theft. Thus, the inventor set out to design a system where lottery tickets are more noticeable by the public and have greater theft prevention. While the inventive concepts disclosed herein are related to lottery ticket dispensers, they should not be limited thereto as they may be applied across various industries and for various goods such as, but not limited to dispensers that dispense medication, personal items (such as tooth brushes), food, and the like.

Disclosed is a modular frame for a plurality of lottery ticket dispensers, the modular frame comprises a top above the plurality of lottery ticket dispensers, a bottom below the plurality of lottery ticket dispensers, a first side on a first side of the plurality of lottery ticket dispensers, and a second side on a second side of the plurality of lottery ticket dispensers, wherein the top, bottom, first side and second side of the modular frame form a rectangular ring around the plurality of lottery ticket dispensers and the top and bottom include lights to illuminate the plurality of lottery ticket dispensers.

Disclosed is a modular frame for a plurality of lottery ticket dispensers, the modular frame comprises a plurality of interconnected top units forming a top of the modular frame, a plurality of interconnected base units forming a base of the modular frame, a first plurality of interconnected side units forming a first side of the modular frame, and a second plurality of interconnected side units forming a second side of the modular frame, wherein the top is a substantially horizontal structure, the bottom is a substantially horizontal structure, and the first and second sides are substantially vertical structures.

### BRIEF DESCRIPTION OF THE DRAWINGS

Example embodiments are described in detail below with reference to the attached drawing figures, wherein:

FIG. 1 is a view of a plurality of lottery ticket dispensers and a modular frame in accordance with example embodiments;

FIG. 2 is a view of a modular frame in accordance with example embodiments;

FIG. 3 is an exploded view of a modular frame in accordance with example embodiments

FIG. 4 is a view an upper unit in accordance with example embodiments;

FIG. 5 shows various views an upper unit in accordance with example embodiments;

FIG. 6 is an exploded view an upper unit in accordance with example embodiments;

FIG. 7 shows various views of elements of an upper unit in accordance with example embodiments;

FIG. 8 shows various views of elements of an upper unit in accordance with example embodiments;

FIG. 9 is a view of a base unit in accordance with example embodiments;

FIG. 10 is another view of a base unit in accordance with example embodiments;

FIG. 11 shows various views of a base unit in accordance with example embodiments;

FIG. 11B shows a side view of two base units connected to each other in accordance with example embodiments;

FIG. 12 is a view of a side unit in accordance with example embodiments;

FIG. 13 shows various views of a side unit in accordance with example embodiments;

FIG. 14 is an exploded view of a side unit in accordance with example embodiments;

FIG. 15 shows various views of an element of a side unit in accordance with example embodiments;

FIG. 16 shows various views of an element of a side unit in accordance with example embodiments;

FIG. 17 is a view of a corner unit of a modular frame in accordance with example embodiments;

FIG. 18 is another view of a corner unit of a modular frame in accordance with example embodiments;

FIG. 19 is another view of a corner unit of a modular frame in accordance with example embodiments;

FIG. 20 is an exploded view of a corner unit of a modular frame in accordance with example embodiments;

FIG. 21 shows various views of a corner unit in accordance with example embodiments;

FIG. 22 is a view of a footing unit in accordance with example embodiments;

FIG. 23 shows various views of a footing unit in accordance with example embodiments;

FIG. 24 shows an exploded view of a footing unit in accordance with example embodiments;

FIG. 25 shows a view of a modular frame to unit connector in accordance with example embodiments;

FIG. 26 shows another view of a connector in accordance with example embodiments;

FIG. 27 shows another view of a connector in accordance with example embodiments;

FIG. 28 shows another view of a connector in accordance with example embodiments;

FIGS. 28A-C show the connector attached to a lottery ticket dispenser in accordance with example embodiments;

FIG. 29 shows a view of a security frame in accordance with example embodiments;

FIG. 30 is an exploded view of the security frame in accordance with example embodiments;

FIG. 31 shows various views of the security frame, a modular frame, and a plurality of lottery ticket dispensers;

FIG. 32 shows a perspective view of a dispenser security bracket in accordance with example embodiments;

FIG. 33 illustrates an exploded view of a dispenser security bracket in accordance with example embodiments;

FIG. 34 illustrates a perspective view of a cam in accordance with example embodiments;

FIGS. 34B and 34C illustrate insertion of a cam into an upper member of a security frame in accordance with example embodiments;

FIG. 35 illustrates a perspective view of a frame hook in accordance with example embodiments;

FIG. 36 illustrates a perspective view of a front cassette hook in accordance with example embodiments;

FIG. 37 illustrates a perspective view of a rear cassette hook in accordance with example embodiments;

FIGS. 38-43 illustrate exemplary operations for attaching a dispenser security bracket to a security frame;

FIGS. 44-45 show adjustability of a dispenser security bracket in accordance with example embodiments;

FIG. 46 illustrates a dispenser security bracket attached to a security frame; and

FIG. 47 illustrates the dispenser security bracket attached to a security frame while also showing a modular frame.

### DETAILED DESCRIPTION

Example embodiments will now be described more fully with reference to the accompanying drawings. Example embodiments are not intended to limit the disclosure since the disclosure may be embodied in different forms. Rather, example embodiments are provided so that this disclosure will be thorough and complete, and will fully convey the scope of the disclosure to those skilled in the art. In the drawings, the sizes of components may be exaggerated for clarity.

In this application, when a first element is described as being “on” or “connected to” a second element, the first element may be directly on or directly connected to the second element or may be on or connected to an intervening element that may be present between the first element and the second element. When a first element is described as being “directly on” or “directly connected to” a second element, there are no intervening elements. In this application, the term “and/or” includes any and all combinations of one or more of the associated listed items.

In this application, spatially relative terms merely describe one element's relationship to another. The spatially relative terms are intended to encompass different orientations of the structure. For example, if a first element of a structure is described as being “above” a second element, the term “above” is not meant to limit the disclosure since, if the structure is turned over, the first element would be “beneath” the second element. As such, use of the term “above” is intended to encompass the terms “above” and “below”. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Example embodiments relate to a modular frame for lottery ticket dispensers and a security frame to protect the same.

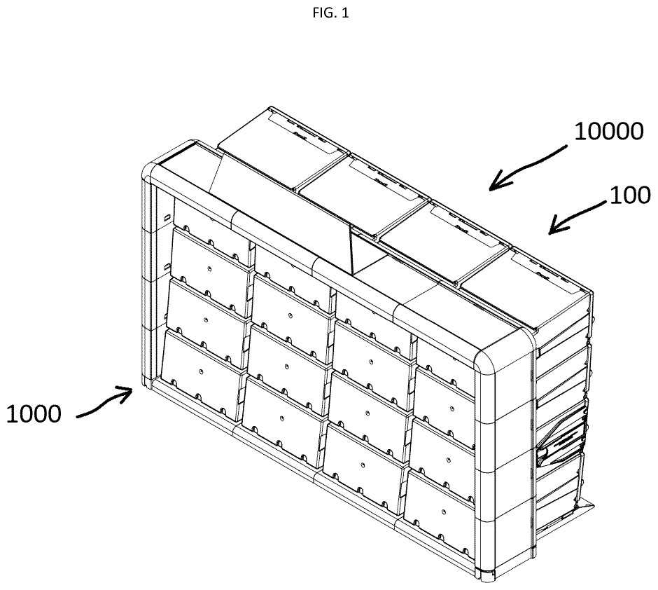

FIG. 1 is a view of a lottery ticket dispenser system 10000 in accordance with example embodiments. As shown in FIG. 1, the lottery ticket dispenser system 10000 includes a plurality of lottery ticket dispensers 100 and a modular frame 1000. In FIG. 1, the plurality of lottery ticket dispensers 100 is shown as including sixteen lottery ticket dispensers arranged in four rows and four columns, but this is just for purpose of illustration as the system may include a plurality of lottery ticket dispensers 100 having more or less than sixteen lottery ticket dispensers. In the conventional art, providing a plurality of lottery ticket dispensers is known, however, lottery ticket dispenser systems having a modular frame 1000, as described herein, is not.

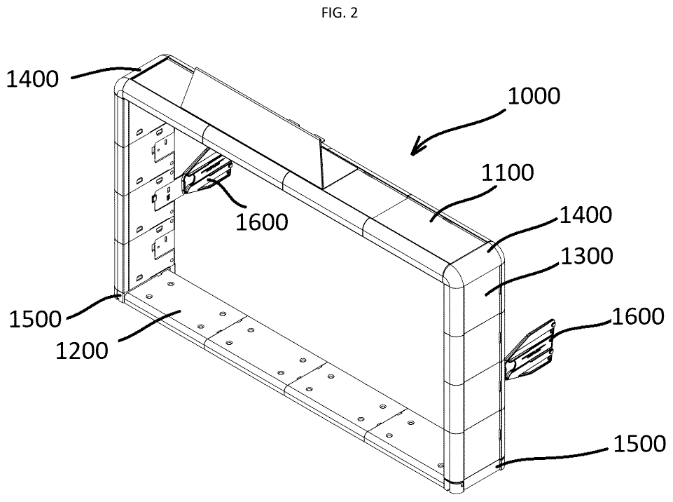

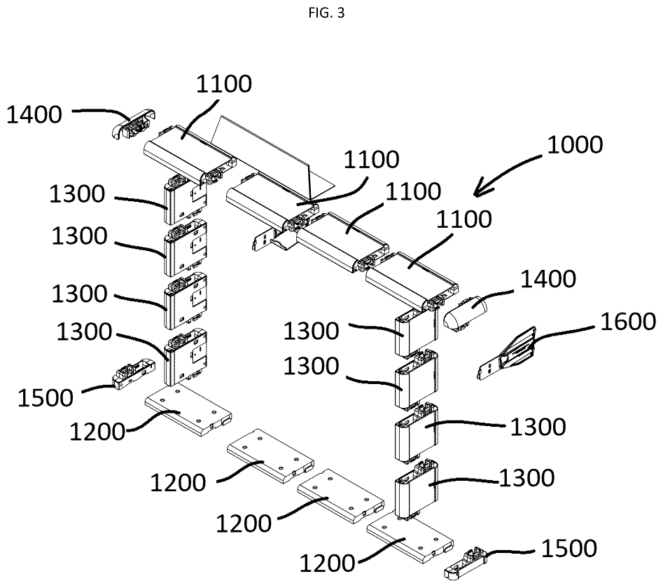

FIG. 2 illustrates an example of a modular frame 1000 in accordance with example embodiments. FIG. 3 illustrates an exploded view of the modular frame 1000 in accordance with example embodiments. As shown in FIGS. 2 and 3 the modular frame 1000 may be comprised of a plurality of interconnecting units forming a rectangular ring. More specifically, the modular frame 1000 includes a plurality of upper units 1100, a plurality of base units 1200, a plurality of side units 1300, two corner units 1400 connecting an upper unit 1100 to a side unit 1300, and two footing units 1500 connecting a side unit 1300 to a base unit 1200. In addition, the modular frame 1000 may include connectors 1600 connecting the modular frame 1000 to the plurality of lottery ticket dispensers 100. In FIGS. 1 and 2, four upper units 1100, four base units 1200, and eight side units 1300 are shown, however, this is merely for the purpose of illustration. For example, if the modular frame 1000 were used with a plurality of lottery ticket dispensers 100 having five rows and six columns of lottery ticket dispensers, then the modular frame 1000 may be comprised of six upper units 1100, six base units 1200, and ten side units 1300 (five on one side of the modular frame 1000, five on another side of the modular frame 1000) to accommodate the plurality of lottery ticket dispensers. As such, the modular frame 1000 may have n number of upper units 1100, n number of base units 1200, and 2×m number of side units, where n represents the number of columns of lottery ticket dispensers in the plurality of lottery ticket dispensers 100 and m represents the number of rows of lottery ticket dispensers in the plurality of lottery ticket dispensers 100.

In example embodiments, the modular frame 1000 may serve several functions. As a first function the modular frame 1000 may include lights to highlight the plurality of ticket dispensers 100. The lights may, for example, draw consumers to areas where the ticket dispensers 100 reside. Second, the lights also may help illuminate the plurality of ticket dispensers 100 enabling a consumer to better see what tickets are actually available. Third, the modular frame 1000, as designed, imparts a pleasing and aesthetic appearance to the plurality of ticket dispensers 100. Fourth, the modular frame 1000 may be designed to work with a security system to enhance security of the plurality of ticket dispensers 100. These are just a few of the practical applications of a modular frame 1000 with respect to a highlighting and protecting a plurality of lottery ticket dispensers 100.

As will be shortly described, each of the upper units 1100, base units 1200, and side units 1300 are configured to attach to each other in a fairly simple manner allowing a top, a bottom, and sides of the modular frame 1000 to be quickly and easily assembled. Furthermore, the corner units 1400 allow for top units 1100 to easily connect to side units 1300 and the footing units 1500 allow for a side unit 1300 to quickly and easily attach to a base unit 1200. Further yet, due to the unique design of the upper units 1100, base units 1200, side units 1300, corner units 1400, and footing units 1500, these members may be connected to one another without having to use tools. In this sense, the modular frame 1000 may be assembled in a toolless manner.

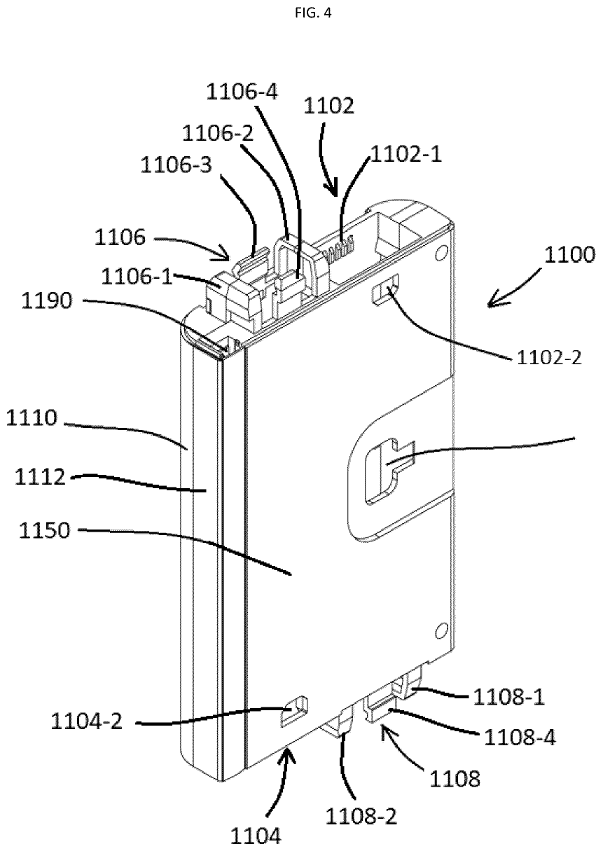

FIG. 4 is a perspective view of an upper unit 1100 in accordance with an example of the invention. In example embodiments each of the upper units 1100 shown in FIGS. 1-3 may be substantially identical. As shown in FIG. 4, the upper unit 1100 may be configured with structures allowing one upper unit 1100 to connect to another upper unit 1100. For example, in FIG. 4, the upper unit 1100 is shown with two connectors, a first connector 1106 and a second connector 1108, and two receiving areas, a first receiving area 1102 and a second receiving area 1104. The first and second connectors 1106 and 1108 are configured to be received in the second and first receiving areas 1104 and 1102 of other upper units 1100 and the first and second receiving areas 1102 and 1104 are configured to receive second and first connectors 1108 and 1106 of other upper units 1100.

In the nonlimiting example provided in FIG. 4, the first connector 1106 may have a pair of substantially rigid tabs 1106-1 and 1106-2 and a pair of resilient members 1106-3 and 1106-4 which may be inserted into a second receiving area 1104 of another upper unit 1100. Likewise, second connector 1108 may include a pair of substantially rigid tabs 1108-1 and 1108-2 and a pair of resilient members 1108-3 and 1108-4 insertable into a first receiving area 1102 of another upper unit 1100. Because connectors 1106 and 1108 are substantially identical and because receiving areas 1102 and 1104 are also substantially identical, only a detailed description of connector 1106 and receiving area 1102 are provided.

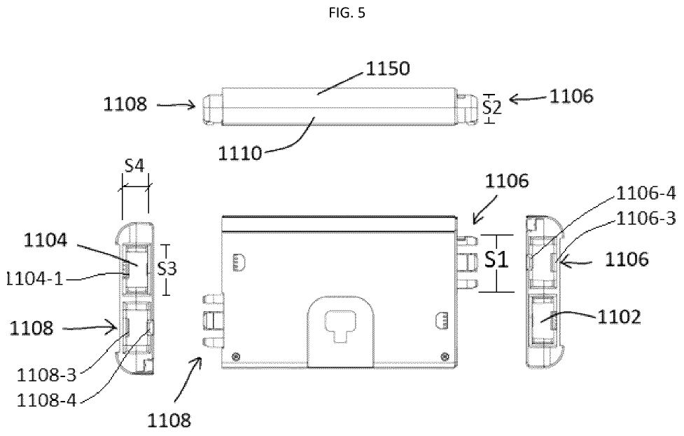

As shown in the various figures, the first connector 1106, may be comprised of a pair of substantially rigid members 1106-1 and 1106-2 and a pair of substantially resilient members 1106-3 and 1106-4. The pair of substantially rigid members 1106-1 and 1106-2 may act as guides to insert the first connector 1106 into the second receiving area 1104 of another upper unit. The footprint of the first connector 1106, as shown in at least FIG. 5, is substantially rectangular having a width S1 and a height S2. The receiving area 1104 also has a substantially rectangular footprint having a width S3 and a height of S4 (noting the receiving area 1102 has substantially the same dimensions). In example embodiments, the width S1 of the first connector's footprint is about the same as or slightly smaller than the width S3 of the second receiving area's footprint. Similarly, the height S2 of the first connector's footprint is about the same as, or slightly smaller than, the height S4 of the second receiving area's footprint. Thus, given the footprint of the second receiving area 1104 is substantially the same as the footprint of the of the first receiving area 1102, it is clear the first connector 1106 of one upper unit 1100 is insertable into the second receiving area 1104 of another upper unit 1100. Similarly, connector 1108 of one upper unit 1100 is insertable into the first receiving area 1102 of another upper unit 1100.

In example embodiments, the receiving areas 1102 and 1104 may have, associated therewith, features allowing the first and second connectors 1106 and 1108 to make the proper connection. For example, as shown in FIG. 4, the first receiving area 1102 may have an aperture 1102-2 sized to accommodate the head of resilient member 1108-4 and one or more protrusion 1102-1 sized to interface with resilient member 1108-3. The second receiving area 1104 has corresponding features 1104-1 and 1104-2. Thus, as the second connector 1108 of one upper unit 1100 is inserted into the first receiving area 1102 of another upper unit 1100 the resilient members 1108-3 and 1108-4 deform slightly until the head of the second resilient member 1108-4 snaps into the aperture 1102-2 of the first receiving area 1102 and the end of the first resilient member 1108-3 is trapped by the protrusions 1102-1 of the first receiving area 1102. Of course, while this is happening the first connector 1106 of one of the upper units 1100 is being inserted into the second receiving area 1104 of the other upper unit 1000 where the end of the resilient member 1106-4 of the first connector snaps into the aperture 1104-2 of the second receiving area 1104 and the resilient member 1106-3 is trapped by the protrusions 1104-1 of the second receiving area 1104. This type of connection allows one upper unit 1100 to quickly connect to another upper unit 1100 without the use of tools. It is understood this type of connection is not meant to limit the invention but merely shows one embodiment where one upper unit 1100 can connect to another upper unit 1100 and that other manners of connecting one upper unit 1100 to another upper unit 1100 are considered to fall within the inventive concepts of this application.

In example embodiments outside edges of the resilient member 1106-4 may actually lie outside of the receiving area's footprint (for example, the footprint of a receiving area 1104). However, because such member is resilient such member may bend inwards as the connector 1106 is inserted into the receiving area 1104 of another upper unit 1100. Such bending imparts a stress to the resilient member 1106-4. The stress urges the outside edges outwards which causes the outside edge of resilient member 1106-4 to snap into aperture 1104-2 and may cause the outside edge of resilient member 1106-3 to press against an inside wall of the upper unit near it's respective features, for example, the features 1104-1 of the attaching upper unit 1100. The same may be true for the resilient members 1108-3 and 1108-4.

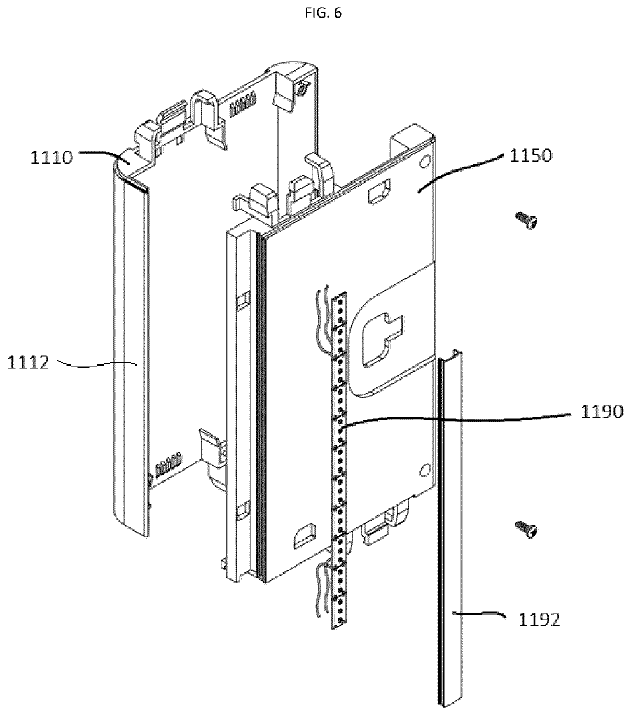

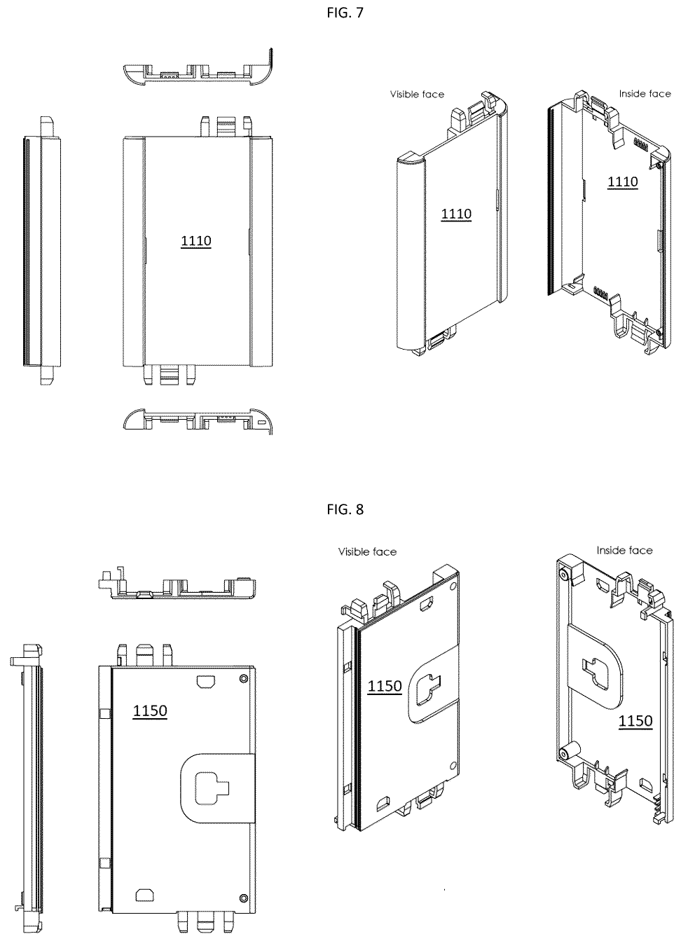

In example embodiments the upper unit 1100 may be manufactured and embodied in various ways. FIG. 6 shows an exploded view of one nonlimiting example embodiment of an upper unit 1100. As shown in FIG. 6, the upper unit 1100 may be formed by creating two separate pieces 1110 and 1150 and connecting them together by a connector, for example, screws, adhesives, etc. In this nonlimiting example embodiment, the first piece 1110, may have a leading edge 1112 so that when joined together with the second piece 1150 a channel is formed. In this embodiment, LED lights 1190 may be placed inside the channel to provide illumination. The channel with the lights 1190 may be covered by a cover 1192 to protect the lights 1190 and provide an aesthetic appearance. FIGS. 7 and 8 provide various views of the separate pieces 1110 and 1150. It is understood the embodiments shown in FIGS. 7 and 8 are for purpose of illustration only and are not meant to limit the invention.

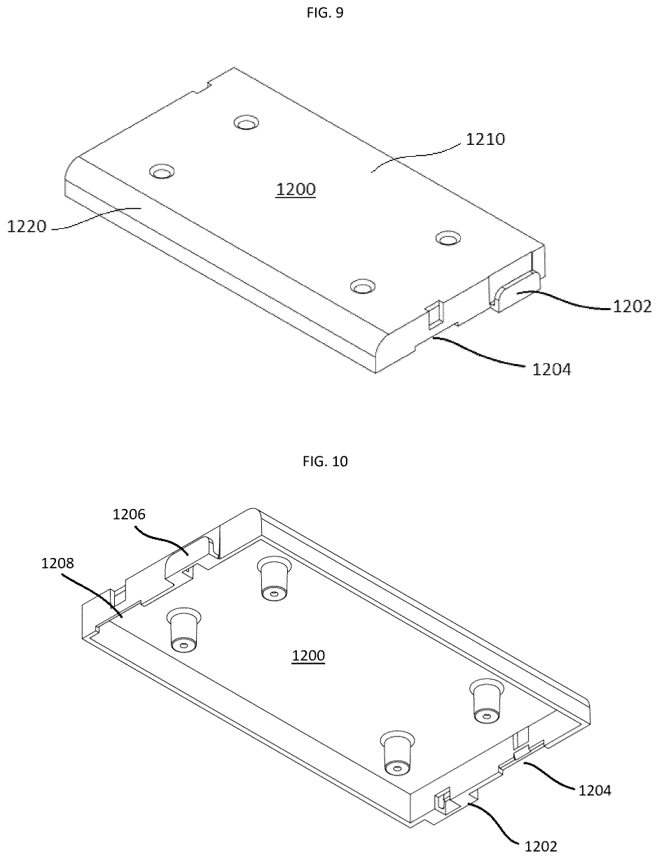

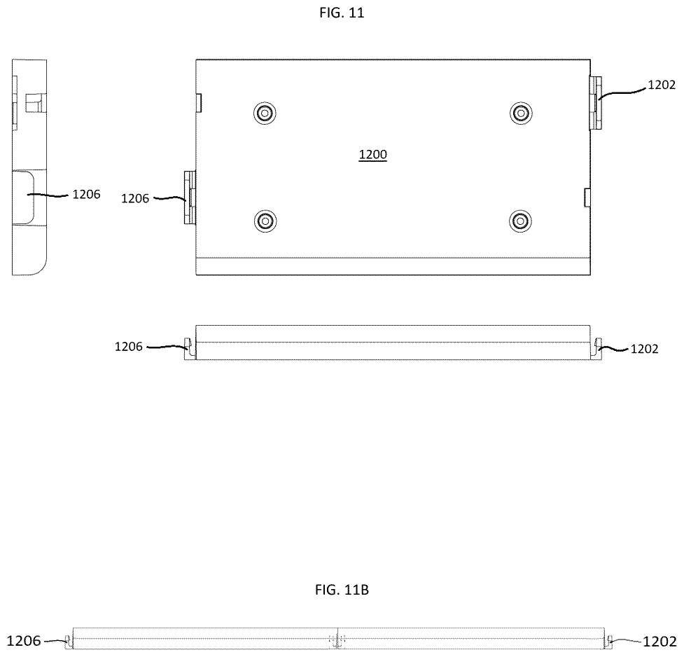

FIGS. 9-11 illustrate an example of a base unit 1200. As shown in FIGS. 9-11 the base unit 1200 may be comprised of a single member having substantially flat top surface 1210 and curved front surface 1220. At either end of the base unit 1200 are slots and tabs which allow one base unit 1200 to connect to another base unit 1200. For example, as shown in FIG. 10, a right side of the base unit 1200 may have a first slot 1204 and a first tab 1202, which, in cross-section, may have a J-shape or L-shape. The left side of the base unit 1200 may include a second slot 1208 and a second tab 1206, which, in cross-section, may also have a J-shape or an L-shape. In practice a first slot 1204 and first tab 1202 of a first base unit 1200 may engage a second tab 1206 and a second slot 1208 of second base unit 1200 to connect the first base unit 1200 to the second base unit 1200. This may be repeated for several base units 1200 to form a base of the modular frame 1000. As one skilled in the art would understand a thickness of wall at an end of the base unit 1200 should be thick enough to reside in a nook of the tabs 1202 and 1206 as shown in FIG. 11B.

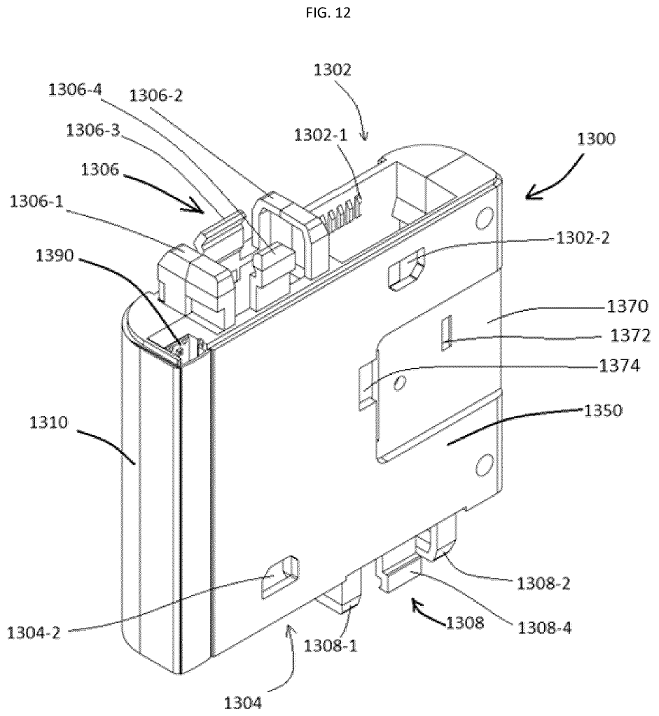

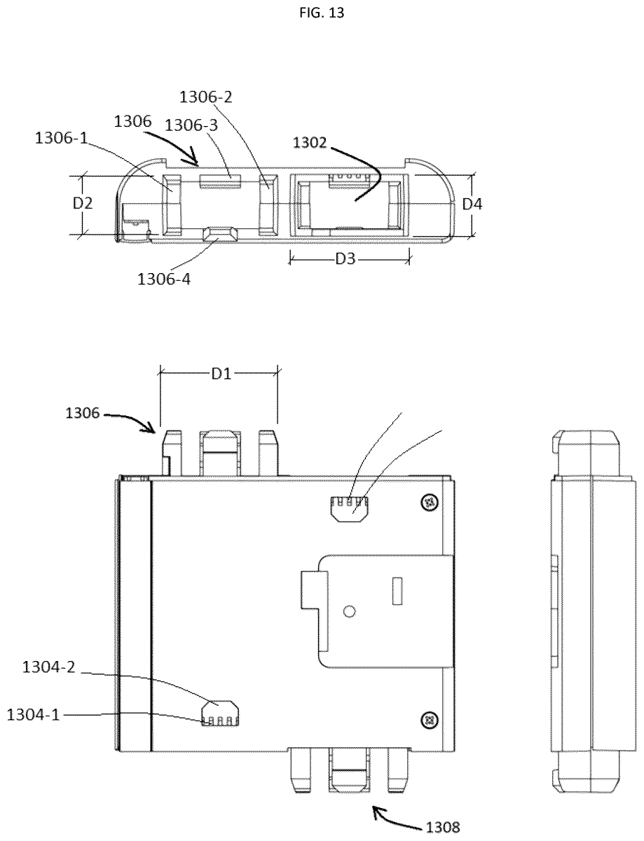

FIG. 12 is a perspective view of side unit 1300 in accordance with an example of the invention. In example embodiments each of the side units 1300 shown in FIGS. 1-3 may be substantially identical. As shown in FIG. 12, the side unit 1300 may be configured with structures allowing one side unit 1300 to connect to another side unit 1300. For example, in FIG. 12, the side unit 1300 is shown with two connectors, a first connector 1306 and a second connector 1308, and two receiving areas 1302 and 1304. In example embodiments the first and second connectors 1306 and 1308 may be configured to be received in receiving areas 1304 and 1302 of other side units 1300. First connector 1306, for example, may have a pair of substantially rigid tabs 1306-1 and 1306-2 and a pair of resilient members 1306-3 and 1306-4. The rigid tabs 1306-1 and 1306-2 may act as guides to guide the first connector 1306 into the second receiving area 1304 of another side unit 1300. Likewise, second connector 1308 may include a pair of substantially rigid tabs 1308-1 and 1308-2 and a pair of resilient members 1308-3 and 1308-4 insertable into a first receiving area 1302 of another side unit 1300. Because connectors 1306 and 1308 are substantially identical and because receiving areas 1302 and 1304 are also substantially identical, only a detailed description of connector 1306 and receiving area 1302 are provided.

As shown in the various figures, the first connector 1306, may be comprised of a pair of substantially rigid members 1306-1 and 1306-2 and a pair of substantially resilient members 1306-3 and 1306-4. The footprint of the first connector 1306 is substantially rectangular having a width D1 and a height D2. The receiving area 1302 also has a substantially rectangular footprint having a width D3 and a height of D4. In example embodiments, the width D1 of the first connector's footprint is about the same as or slightly smaller than the width D3 of the first receiving area's footprint. Similarly, the height D2 of the first connector's footprint is about the same as, or slightly smaller than, the height D4 of the first receiving area's footprint. Thus, given the footprint of the second receiving area 1304 is substantially the same as the footprint of the of the first receiving area 1302, it is clear the connector 1306 of one side unit 1300 is insertable into the second receiving area 1304 of another side unit 1300. Similarly, connector 1308 of one side unit 1300 is insertable into the first receiving area 1302 of another side unit 1300.

In example embodiments, the receiving areas 1302 and 1304 may have, associated therewith, features allowing the first and second connectors 1306 and 1308 to make the proper connection. For example, as shown in FIG. 12, the first receiving area 1302 may have an aperture 1302-2 sized to accommodate the head of resilient member 1308-4 another side unit 1300 and a series of protrusion 1302-1 sized to interface with resilient member 1308-3 of the other side unit 1300. The second receiving area 1304 has corresponding features 1304-1 and 1304-2. Thus, as the second connector 1308 of one side unit 1300 is inserted into the first receiving area 1302 of another side unit 1300 the resilient members 1308-3 and 1308-4 deform slightly until the head of the second resilient member 1308-4 snaps into the aperture 1302-2 of the first receiving area 1302 and the end of the first resilient member 1308-3 is trapped by the protrusions 1302-1 of the first receiving area 1302. Of course, while this is happening the first connecter 1306 of the side unit 1300 is being received into the second receiving area 1304 to be connected in a similar manner. This type of connection allows one side unit 1300 to quickly connect to another side unit 1300. As one skilled in the art would readily appreciate, one side unit 1300 may be connected to another side unit 1300 using the first connector 1306 of one side unit 1300 and the second receiving area 1304 of the other side unit 1300.

In example embodiments outside edges of resilient member 1306-4 may actually lie outside of the receiving area's footprint (for example, the footprint of a receiving area 1304). However, because such member is resilient such member may bend inwards as the connector 1306 is inserted into the receiving area 1304 of another side unit 1300. Such bending imparts a stress to the resilient member 1306-4. The stress urges the outside edges outwards which causes the outside edge of resilient member 1306-4 to snap into aperture 1304-2 and may urge the outside edge of resilient member 1306-3 to press against an inside wall of the side unit near it's respective features, for example, the features 1304-1 of the attaching side unit 1300. The same may be true for the resilient members 1308-3 and 1308-4.

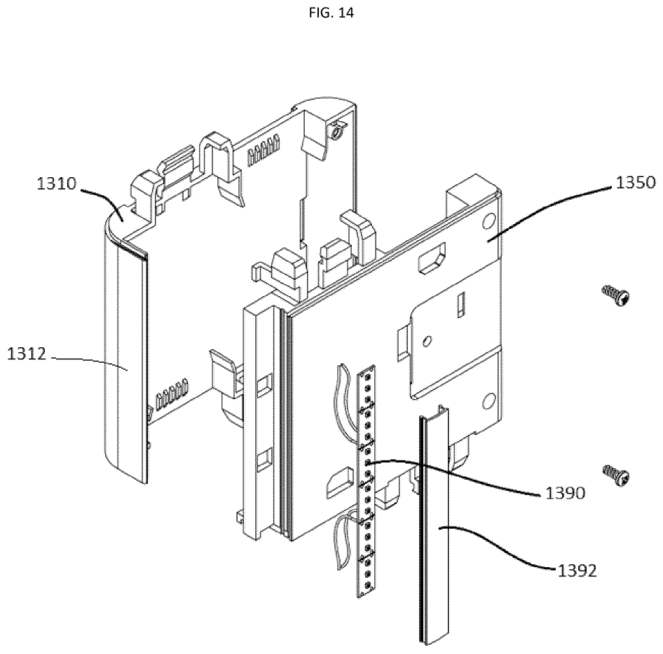

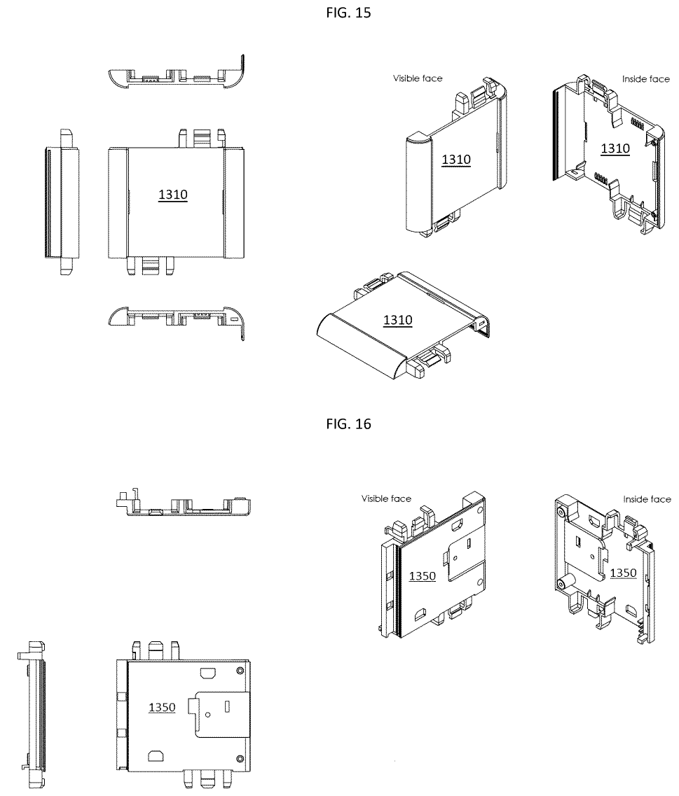

In example embodiments the side unit 1300 may be manufactured and embodied in various ways. FIG. 14 shows an exploded view of one nonlimiting example embodiment of a side unit 1300. As shown in FIG. 14, the side unit 1300 may be formed by creating two separate pieces 1310 and 1350 and connecting them together by a connector, for example, screws, adhesives, etc. In this nonlimiting example embodiment, the first piece 1310, may have a leading edge 1312 so that when joined together with the second piece 1350 a channel is formed. In this embodiment, LED lights 1390 may be placed inside the channel to provide illumination. The channel with the lights 1390 may be covered by a cover 1392 to protect the lights 1390 and provide an aesthetic appearance. FIGS. 15 and 16 provide various views of the separate pieces 1310 and 1350. It is understood the embodiments shown in FIGS. 15 and 16 are for purpose of illustration only and are not meant to limit the invention.

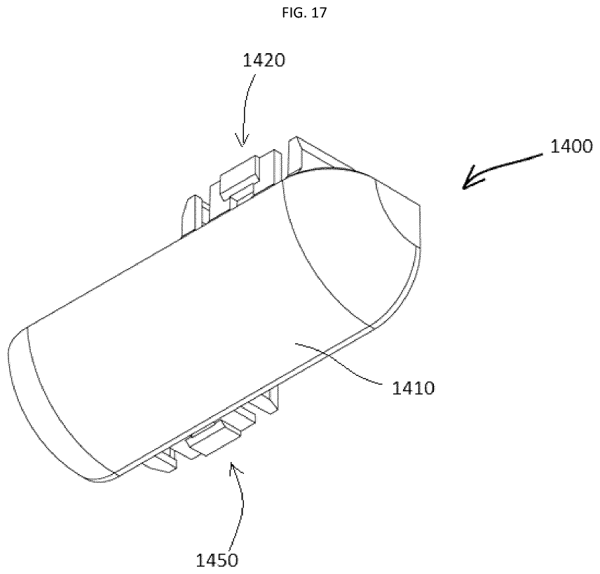

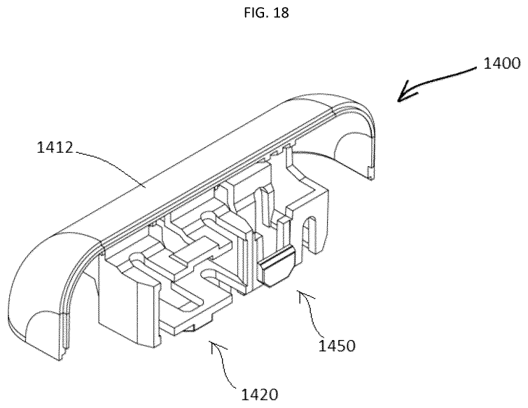

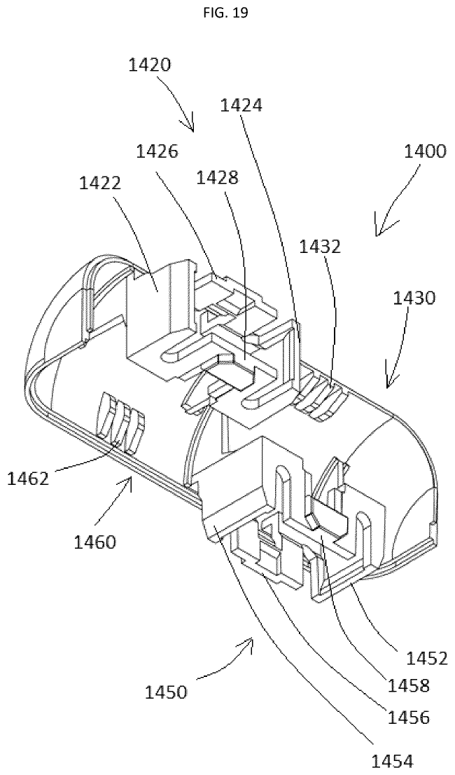

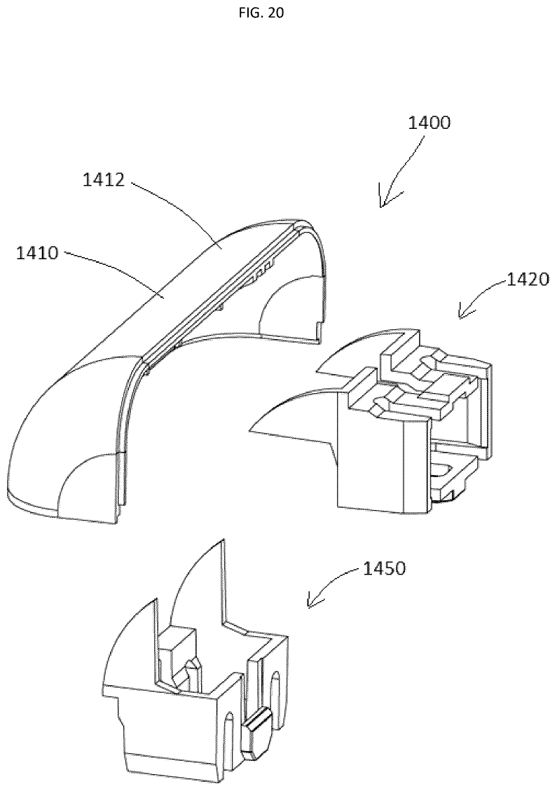

FIGS. 17-19 are views of a corner unit 1400 in accordance with example embodiments. FIG. 20 is an exploded view of the example corner unit 1400. FIG. 21 offers a top, a bottom, and side views of the exemplary corner unit 1400. As shown in FIGS. 17-21, the exemplary corner unit 1400 includes an outer shell 1410 into which two couplers 1420 and 1450 may be inserted (noting 1420 and 1450 in at least one embodiment may be identical). The couplers 1420 and 1450 are generally disposed ninety degrees to each other and offset to different ends of the outer shell 1410. The couplers 1420 and 1450 are intended couple to the upper and side units 1100 and 1300. In this sense, the couplers 1420 and 1450 are configured somewhat similar to the previously described connectors.

As shown in the various figures the outer shell 1410 has an arcuate surface 1412 when viewed from the side. This aspect of the outer shell 1410 serves two purposes. The first is to provide an aesthetic appearance, the second is to avoid having a sharp edge which might render the outer shell 1410 vulnerable to damage from an impact. It is understood, however, that having an arcuate surface 1412 is not critical to the invention as the surface, while not ideal, may still resemble two flat surfaces joining together to form a sharp corner. Of course, other embodiments fall within the inventive concepts. For example, the surface 1412 may resemble a chamfered surface having angles less than ninety degrees.

In example embodiments, the first coupler 1420 may be configured to insert into the second receiving area 1104 of an upper unit 1100. To this end, the corner unit 1400 includes a first receiving area 1430 to receive the second connector 1108 of the upper unit 1100. The first coupler 1420 may include two substantially rigid members 1422 and 1424 and two substantially resilient members 1426 and 1428 so that when the first coupler 1420 is inserted into the second receiving area 1104 an end of the second resilient member 1428 resides in the aperture 1104-2 of the second receiving area 1104 and an end of the first resilient member 1426 is retained by the features 1104-1 of the second receiving area 1104. When this happens the second connector 1108 of the upper unit 1100 is inserted into the receiving space 1430 of the corner unit 1400 where the resilient member 1108-3 is retained by features 1432 formed on the inside of the shell 1410.

In example embodiments, the second coupler 1450 may be configured to insert into the first receiving area 1302 of side unit 1300. To this end, the corner unit 1400 includes a second receiving area 1460 to receive the first connector 1306 of the side unit 1300. The second coupler 1450 may include two substantially rigid members 1452 and 1454 and two substantially resilient members 1456 and 1458 so that when the second coupler 1450 is inserted into the first receiving area 1302 an end of the second resilient member 1458 resides in the aperture 1302-2 of the first receiving area 1302 and an end of the first resilient member 1456 is retained by the features 1302-1 of the first receiving area 1302. When this happens the first connector 1306 of the side unit 1300 is inserted into the receiving area 1460 of the corner unit 1400 where the resilient member 1306-3 is retained by features 1462 formed on the inside of the shell 1410.

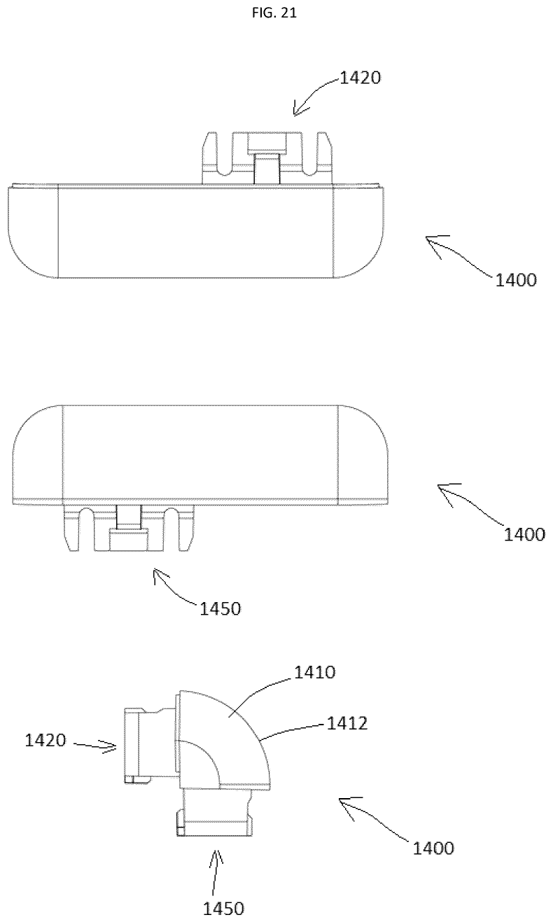

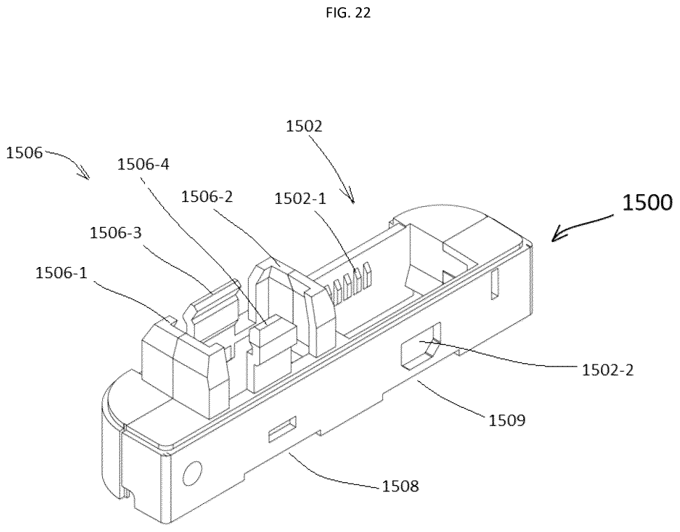

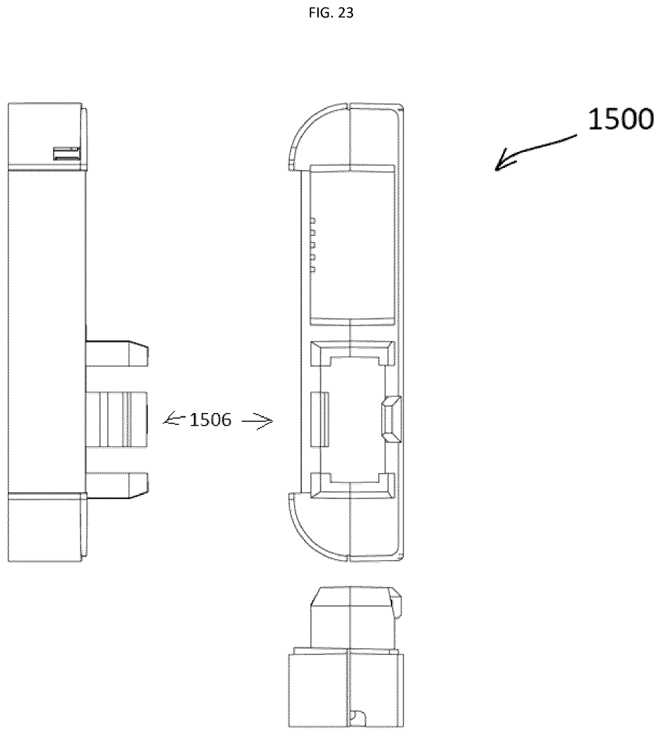

FIG. 22 is a perspective view of a footing unit 1500 in accordance with an example of the invention. FIG. 23 shows different views of the footing unit 1500 and FIG. 24 shows an explode view of the footing unit 1500. In example embodiments both of the footing units 1500 shown in FIGS. 1-3 may be substantially identical.

As shown in FIG. 22, the footing unit 1500 may be configured with structures allowing it to connect to a side unit 1300 and a base unit 1200. For example, in FIG. 22, the footing unit 1500 is shown with a first connector 1506 enabling the footing unit 1500 to connect to a side unit 1300, a receiving area 1502 to receive a connector from the side unit 1300, and depressions 1508 and 1509 to receive and trap the tabs 1202 and 1206 of the base units 1200 (noting that, in this nonlimiting example embodiment only one of the tabs 1202 and 1206 will actually serve as a connection between a base unit 1200 and the footing unit 1500).

In the nonlimiting embodiment of FIG. 22 the connector 1506 may be comprised of a pair of substantially rigid members 1506-1 and 1506-2 and a pair of substantially resilient members 1506-3 and 1506-4. The pair of substantially rigid members 1506-1 and 1506-2 may act as guides to insert the first connector 1506 into a receiving area of a side unit 1300, for example, the second receiving are 1304. The footprint of the first connector 1506 is substantially rectangular and substantially the same size, or slightly smaller than, the footprint of the receiving area of the side unit 1300. Thus, in view of this, the connector 1506 is insertable into the receiving area of the side unit 1300. The receiving area 1502 may have a foot print substantially the same size as (or slightly larger than) a connector, for example, the second connector 1308 of the side unit 1300. Thus, the second connector 1308 of the side unit may be inserted into the receiving area 1502 of the footing unit 1500.

In example embodiments outside edges of the resilient member 1506-4 may actually lie outside of the receiving area's footprint (for example, the footprint of a receiving area 1304). However, because such member is resilient such member may bend inwards as the connector 1506 is inserted into the receiving area 1304 of side unit 1300. Such bending imparts a stress to the resilient members 1506-4. The stress urges the outside edges of the resilient member 1506-4 outwards which causes the outside edge of resilient member 1506-4 to snap into aperture 1304-2 and may urge the outside edge of resilient member 1506-3 to press against an inside wall of the side unit near its respective features, for example, the features 1304-1. Similarly, outside edges of the resilient member 1308-4 may actually lie outside of the receiving area's footprint (for example, the footprint of a receiving area 1502). However, because such member is resilient such member may bend inwards as the connector 1308 is inserted into the receiving area 1502 of the footing unit 1500. Such bending imparts a stress to the resilient member 1308-4. The stress urges the outside edges outwards which causes the outside edge of resilient member 1308-4 to snap into aperture 1502-2 and may urge the outside edge of resilient member 1308-4 to press against an inside wall of the footing unit near it's respective features, for example, the features 1502-1.

In example embodiments, the receiving areas 1502 may have, associated therewith, features allowing the connector of a side unit 1300 to make the proper connection. For example, as shown in FIG. 22, the receiving area 1502 may have an aperture 1502-2 sized to accommodate the head of resilient member 1308-4 and a series of protrusion 1502-1 sized to interface with resilient member 1308-3. Thus, as the connector 1308 of a side unit 1300 is inserted into the receiving area 1502 the resilient members 1308-3 and 1308-4 deform slightly until the head of the second resilient member 1308-4 snaps into the aperture 1502-2 of the receiving area 1502 and the end of the first resilient member 1308-3 is trapped by the protrusions 1502-1. This type of connection allows one side unit 1300 to quickly connect to the footing unit 1500. It is understood this type of connection is not meant to limit the invention but merely shows how one example side unit 1300 can connect to a footing unit 1500 and that other manners of connecting a side unit 1300 to a footing unit 1500 are considered to fall within the inventive concepts of this application.

In example embodiments the footing unit 1500 may be manufactured and embodied in various ways. FIG. 24 shows as exploded view of one nonlimiting example embodiment of a footing unit 1500. As shown in FIG. 24, the footing unit 1500 may be formed by creating two separate pieces 1510 and 1550 and connecting them together by a connector, for example, screws, adhesives, etc. It is understood the embodiments shown in FIGS. 22-24 are for purpose of illustration only and are not meant to limit the invention.

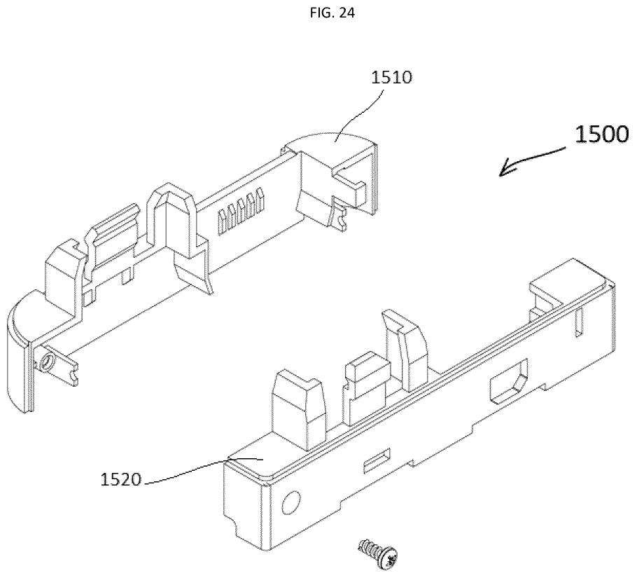

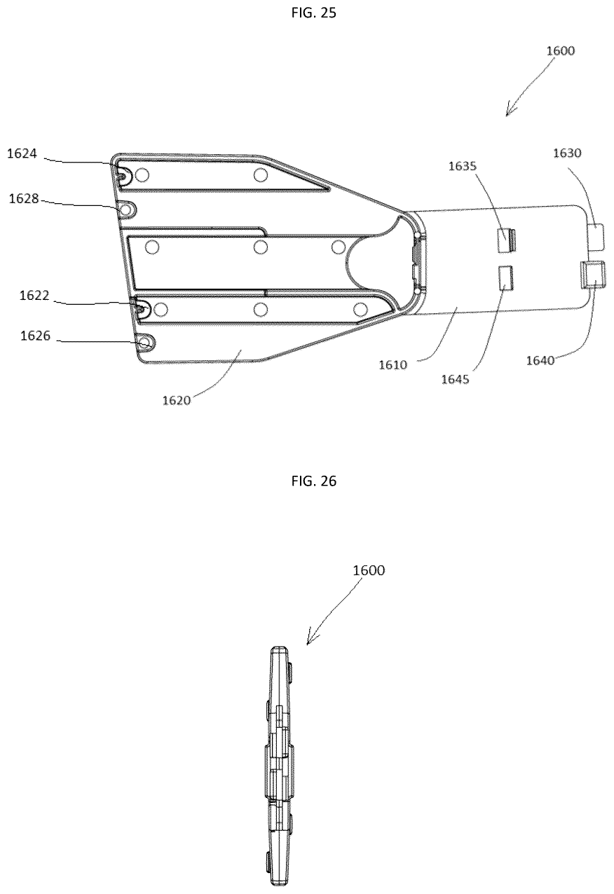

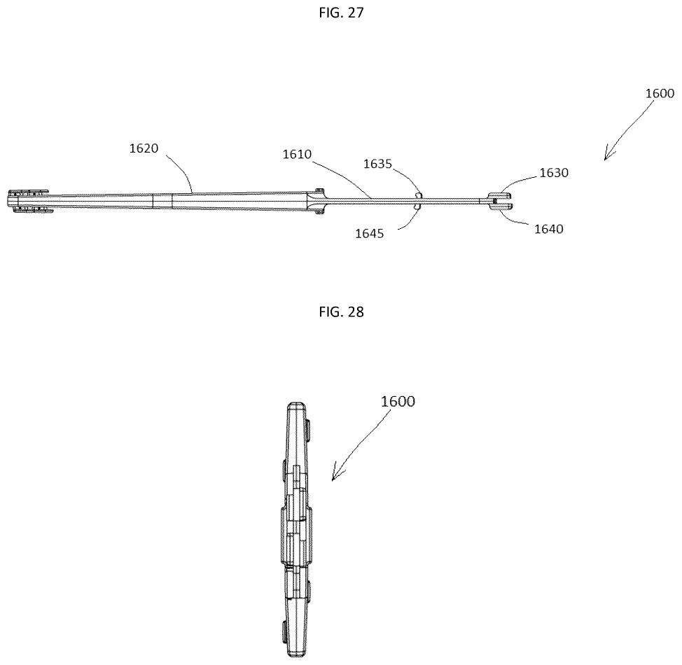

Thus far the detailed description has described elements for an exemplary modular frame 1000. More specifically, exemplary upper units 1100, base units 1200, side units 1300, corner units 1400, and footing units 1500 have been described. An upper portion of the modular frame 1000 can be formed by connecting together various upper units 1100 as described above. The sides of the modular frame 100 can be formed by connecting together various side units 1300, also as described above. A base of the modular frame 1000 may be formed by connecting together the various base units 1200. Finally, the upper portion and the sides of the modular frame 1000 can be connected to each other using the exemplary corner units 1400 and the sides of the modular frame 1000 can be connected to the base using the footing units 1500. The modular frame 1000 can be connected to a plurality of lotter ticket dispensers using connectors 1600. An exemplary connector 1600 is shown in FIGS. 25-28, which represents various views of the connector 1600.

Referring to FIG. 25 the exemplary connector 1600 includes a neck 1610 for attaching to a side unit 1300 and a base 1620 for attaching to a lottery ticket dispenser (which may be part of a plurality of ticket dispensers). As shown in at least FIG. 25 the neck 1610 has an end with a pair of tabs 1630 and 1640 on opposite sides of the connector 1600. In the middle of the neck are a pair of protrusions 1635 and 1645 also arranged on opposite sides of the neck 1600. The neck 1610 may be associated with connector receiving area 1370 of a side unit 1300. More specifically, the connector receiving area 1370 may resemble a depression to receive the neck 1610. The neck 1610 may resemble a flat plate having a thickness and the depression (of the receiving area 1370) may have a depth about equal to the thickness of the neck 1610. The connector receiving area 1370 may include a first notch 1374 for receiving one of the tabs 1630 and 1640 (noting, due to symmetry of this example embodiment the exemplary connector 1600 may be flipped and usable in the flipped state) and a second notch 1372 for receiving one of the protrusions 1635 and 1645. In example embodiments the tabs 1630 and 1640 and the notches 1372 and 1374 may be configured to promote a snap type of connection such that a user may simply press on the neck 1610 to push the tabs and protrusions into their respective notches. This, of course, is not meant to limit the invention as the inventive concepts envision other manners of connecting the connector 1600 to the side unit 1300.

Additionally, the base 1620 may have a pair of hooks 1622 and 1624 on one side of the connector 1600 and another pair of hooks 1626 and 1628 on another side of the connector 1600. The pairs of hooks 1622 and 1624 and 1626 and 1628 may be configured to receive a sidewall of a lottery ticket dispenser. For example, in cross section, the hooks 1622, 1624, 1626, and 1628 may be somewhat J-shaped to receive a sidewall of a lottery ticket dispenser. When installed, the neck 1610 of the connector 1600 attaches to the side units 1300 using the protrusions (one of 1635 and 1645) and tabs (one of 1630 and 1640) while the base 1620 of the connector 1600 attaches to a side wall of a lottery ticket dispenser using a pair of hooks (either 1622 and 1624 or 1626 and 1628).

FIG. 2 illustrates an example of the modular frame 1000 using two connectors 1600, one which attaches to a column of side units 1300 on a right side of the modular frame 1000, and another which attaches to a left side of the modular frame 1000. This is not intended to limit the invention as more than one connector 1600 may attach to the columns of side units 1300 on the left and right side of the modular frame 1000.

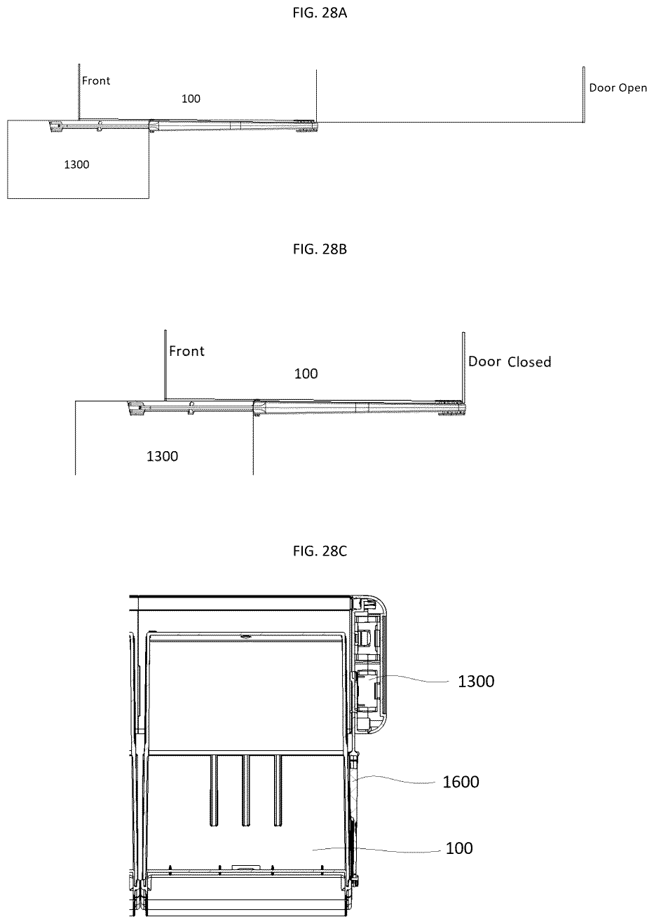

FIG. 28A is a schematic view showing the connector 1600 connected to one of the side units 1300 as well as having a side of a lottery ticket dispenser 100 be inserted into one of the aforementioned pairs of hooks. FIG. 28A illustrates and example where a door of the lottery ticket dispenser 100 is opened. When the door is closed the hooks of the connector 1600 are trapped by the door and the side wall of the lottery ticket dispenser 100 as shown in FIG. 28B. FIG. 28C better shows the hooks being captured by the door of the lottery ticket dispenser 100

Thus far, various structural features associated with the modular frame 1000 have been described. So far as material selection goes, many materials are usable with this design. In one particularly useful nonlimiting example embodiment a transparent or translucent material, for example, a transparent or translucent plastic, may be used to manufacture at least the upper units 1100 and the side units 1300. Using such materials makes the lights that may be contained therein visible to a consumer and may direct the consumer's attention to the modular frame associated with a plurality of lottery tickets.

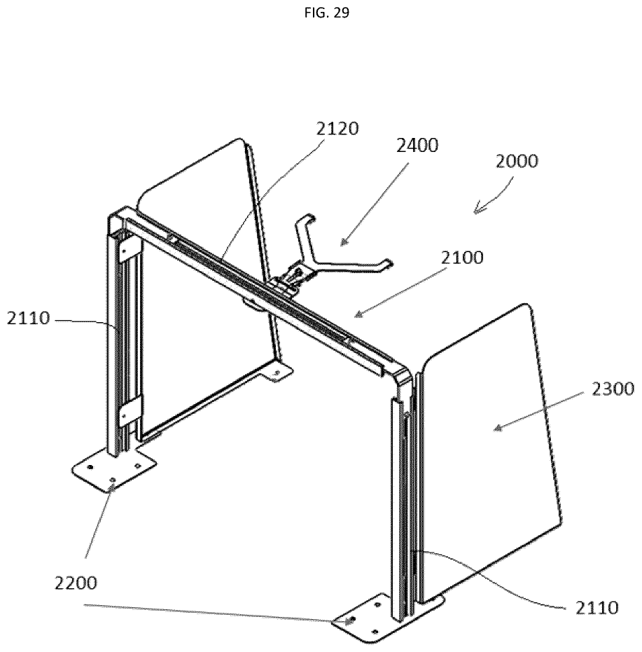

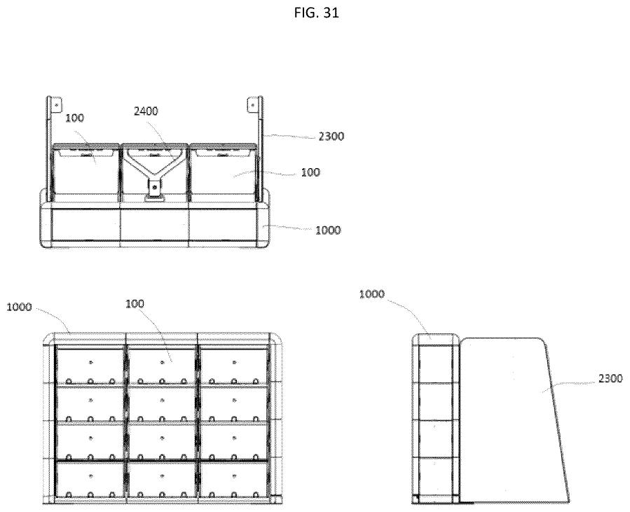

As one skilled in the art would likely appreciate, lottery ticket dispensers may house a number of extremely valuable tickets which are often the target of theft. Thus, to increase security, example embodiments also include an antitheft frame 2000 as shown in FIG. 29. As shown in FIG. 29, the antitheft frame 2000 may include a frame 2100, for example, an aluminum frame, having counter fixings 2200 which may allow the frame 2100 to attach to a countertop. The frame 2100, in one nonlimiting example embodiment, may have vertical legs 2110 and a horizontal top 2120 which runs above the plurality of lottery ticket dispensers which may be associated with the modular frame 1000. The antitheft frame 2000 may further include anti reach around shields 2300 to prevent a consumer from reaching around the modular frame to gain access to the plurality of lottery ticket dispensers. In addition, the antitheft security frame 2000 may further include a dispenser security bracket 2400 which may extend from the top 2120 of the frame 2100 and across at last one of the lottery ticket dispensers. FIG. 31 shows various views of the security frame 2000 used in conjunction a modular frame 1000 and a plurality of lottery ticket dispensers 100.

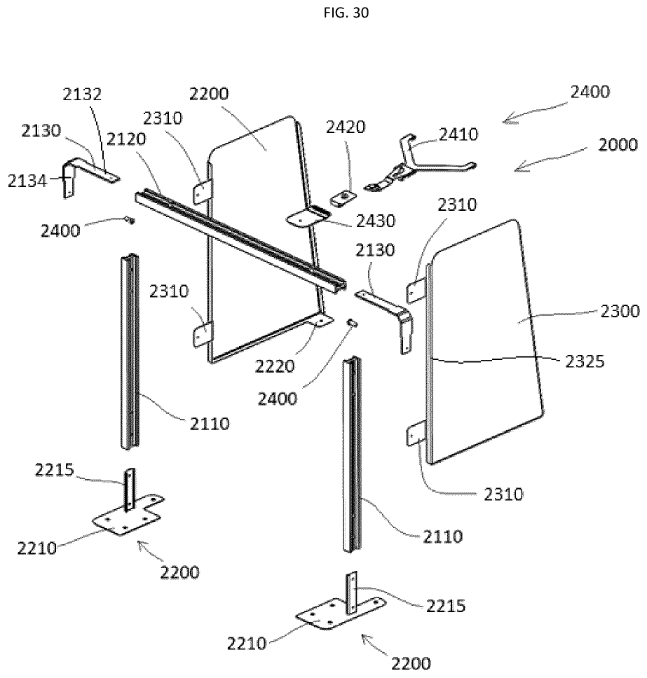

FIG. 30 shows additional details of the nonlimiting exemplary antitheft frame 2000. As shown in FIG. 30, the vertical legs 2110 and the horizontal top 2120 may be substantially straight elongated members having an I-cross section. This aspect of the vertical legs 2110 and the horizontal top 2120, however, is not meant to limit the invention as the vertical legs 2110 and the horizontal top 2120 may have another type of cross-section such as, but not limited to, a square cross-section, a rectangular cross section, a C-shaped cross-section, an L-shaped cross-section, and an H-shaped cross-section. In this nonlimiting example embodiment, corner brackets 2130 may be used to connect the horizontal top 2120 to the vertical legs 2110. As shown in the figures, the corner brackets 2130 may resemble L-shaped members having a substantially horizontal member 2132 interfacing with the horizontal top 2120 and a substantially vertical member 2134 interfacing with the vertical legs 2110. Though not required, the horizontal members 2132 and the vertical members 2134 of the corner brackets 2130 may form a substantially ninety degree angle, though the invention is not limited thereto.

In example embodiments, the counter fixings 2200 may be composed of at least two parts including a substantially flat base 2210 which may allow the counter fixings 2200 to attach to a flat surface such as, but not limited to, a countertop, and a vertical member 2215 which may interface with the vertical legs 2110. Thus, when the counter fixings 2200 are attached to the vertical legs 2210 and the vertical legs 2210 are attached to the horizontal top 2120 a substantially U-shaped structure is formed which is attachable to a counter top.

As for the anti reach around shields 2300, each shield 2300 may include connection tabs 2310 enabling the anti reach around shields 2300 to attach to the vertical legs 2210. In one embodiment, the anti reach around shields 2300 may be constructed with a relatively flat body 2320 which may include a recessed area 2325 to which the connection tabs 2310 attach. The recessed area 2325 may allow the connection tabs 2310 to be offset from the flat body 2320 and allow the connection tabs 2310 to attach on the inside faces of the vertical legs 2110 as shown in FIG. 29.

As for connecting the various elements together, a skilled artisan would recognize a number of ways to connect the various elements together. For example, on skilled in the art would understand various ways of connecting the corner brackets 2130 to the horizontal top 2120 and the vertical legs 2110. Similarly, one skilled in the art would recognize a number of ways to connect the vertical legs 2110 to the counter fixings 2200. In the nonlimiting example of FIGS. 29-31, for example, the horizontal top 2120, vertical legs 2110, corner brackets 2130, counter fixings 2200, and anti reach around shields 2300 may each include apertures allowing connecting members, for example, screws and pins, to attach the various members together.

The dispenser security bracket 2400, in one nonlimiting example embodiment, may include a connector 2430 configured to attach to the horizontal top 2120. The attachment may, in one nonlimiting example embodiment, be a bolt or pin style attached. Attached to the connector 2410 is a central connecting member 2420 which connects the connector 2430 to a hook 2410. The central connecting member 2420 may include a not an bolt in a slot to provide adjustability and so it can be tightened back to pick up any slack. Having the adjustability is important since the plurality of lottery ticket dispensers 100 may have a lean which increases more ticket dispensers 100 are stacked on top of one another. This “lean” is depicted in FIG. 1 by the plurality of ticket dispensers 100.

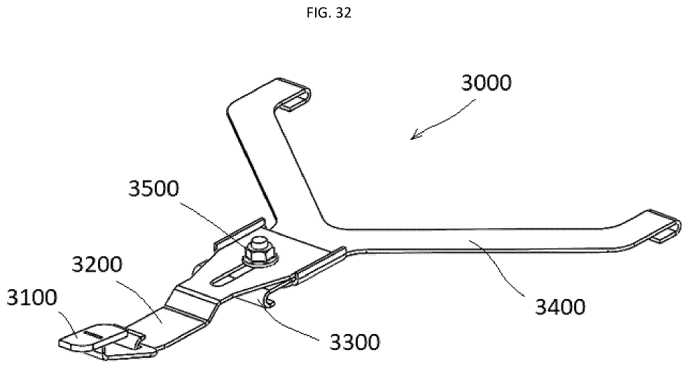

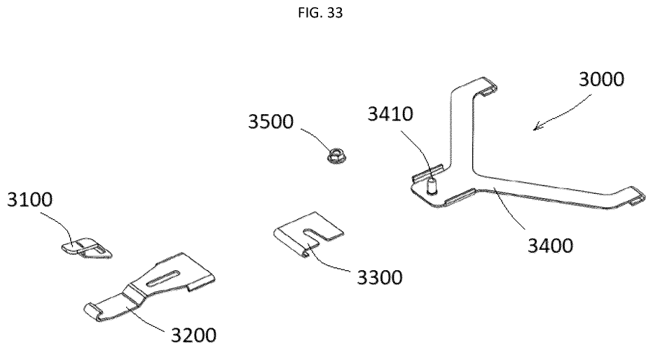

Example embodiments are not intended to be limited by any of the aforementioned embodiments. For example, FIG. 32 illustrates another example of a dispenser security bracket 3000 usable with example embodiments. FIG. 33 is an exploded view of the exemplary dispenser security bracket 3000. As shown in FIGS. 32 and 33, the exemplary dispenser security bracket 3000 may include a cam 3100, a frame hook 3200, a front cassette hook 3300, and a rear cassette hook 3400 (noting, in this application, a cassette is a single lottery ticket dispenser). As shown in at least FIG. 33, the rear cassette hook 3400 includes a protrusion 3410 which may be threaded to engage a securing member 3500 which, in one nonlimiting example embodiment may be a nut. In example embodiments, the protrusion 3410 and securing member 3500 may lock the frame hook 3200, the front cassette hook 3300 and the rear cassette hook 3400 in place.

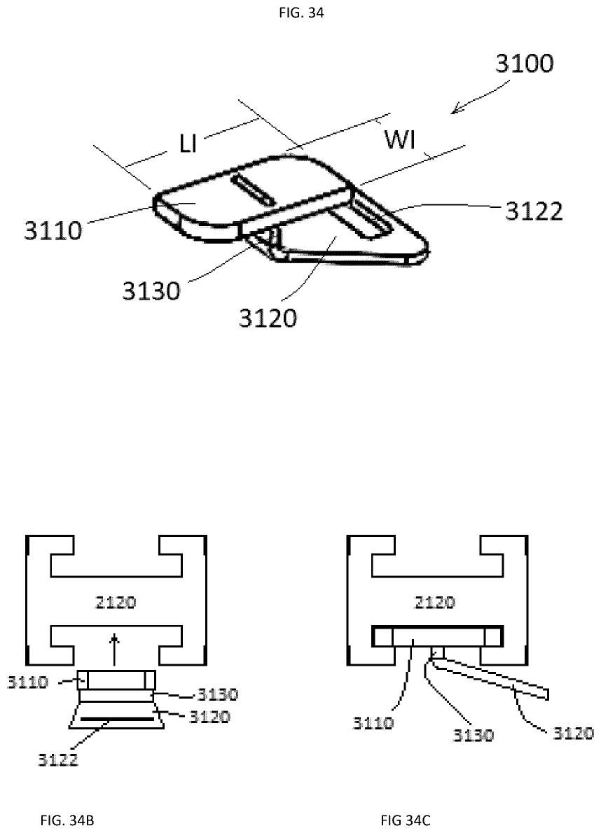

FIG. 34 is a perspective view of the cam 3100 in accordance with example embodiments. As shown in FIG. 34, the cam 3100 may have an interfacing member 3110 and a frame hook connecting plate 3120 joined by a connecting member 3130. In this nonlimiting example embodiment, interfacing member 3110 may have features enabling it to interface with the top 2120 of the frame 2100. For example, as shown in at least FIG. 34, an example of the interfacing member 3110 of the cam 3100 may resemble a plate having a width WI which shorter than a length LI of the interfacing member 3110. Such an arrangement may be useful in attaching the cam 3100 to the top 2120 when the top 2120 is configured as having a sidewise “I” cross-section with flanged ends as shown in FIG. 34B. For example, in this nonlimiting example embodiment, the width WI may be short enough to allow the interfacing member 3110 to be inserted between the flanged ends of the top 2120 as shown in FIG. 34B. Once the interfacing member 3110 of the cam 3100 passes the flanged ends, the cam 3100 may be rotated so that it's length LI extends above the flanged ends of the top 2120 as shown in FIG. 34D thus preventing the cam 3100 from being pulled out of the top 2120.

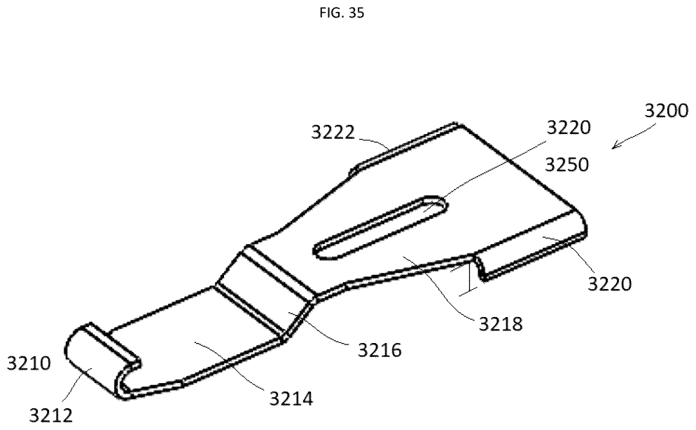

FIG. 35 is a view of an exemplary frame hook 3200 in accordance with example embodiments. As shown in FIG. 35, the exemplary frame hook 3200 may have a first end 3210 and a second end 3250. The first end 3210 may include a curved end 3212 which may function as a hook and which be inserted into a slot 3122 of the cam 3100. In this way the frame hook 3200 may hingedly attach to the cam 3100. Extending from the curved end 3212 is a an extension plate 3214 which may extend to a transition plate 3216 which may extend at an angle from the extension plate 3214. The transition plate 3216 may, in turn, extend to an engagement plate 3218 which may include spacers 3220 and 3222 arranged at the sides of the engagement plate 3218. The spacers 3220 and 3222 may allow for the front cassette hook 3300 to reside therein. In addition to the above described features the engagement plate 3218 may include a slot 3220 which may extend in a direction parallel to a direction that extends from the first end 3210 to the second end 3250. As will be explained shortly, the slot 3220 may allow for adjustability of the dispenser security bracket 3000. In example embodiments the exemplary frame hook 3200 may be fabricated from a metal plate utilizing various bending operations. Thus, the exemplary frame hook 3200 may have a substantially constant thick, though this limitation is not critical to the invention. It is understood that while the exemplary frame hook 3200 may be made from metal, this is not intended to limit the invention as the exemplary frame hook 3200 may be made from other materials such as, but not limited to, plastic.

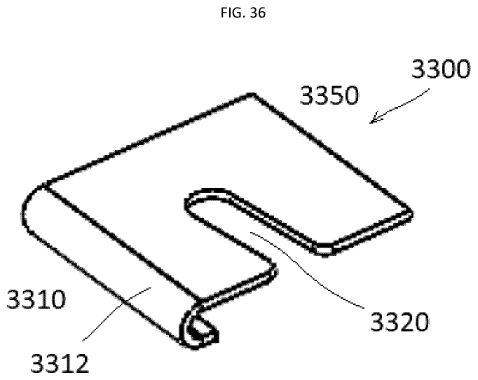

FIG. 36 is a perspective view of an exemplary front cassette hook 3300. As shown in FIG. 36, the exemplary front cassette hook 3300 may include a first end 3310 and a second end 3350. The first end 3310 of the exemplary cassette hook 3300 may resemble a curved end 3312 which may be configured to receive a feature of a lottery ticket dispenser. The feature could be a roof or bar which may be on one side of the lottery ticket dispenser. Between the first end 3310 and the second end 3350 of the exemplary cassette hook 3300 is a slot 3320 which may allow for the protrusion 3410 of the rear cassette hook 3400 to extend therethrough. In example embodiments the exemplary front cassette hook 3300 may be fabricated from a metal plate utilizing various bending operations. Thus, the exemplary front cassette hook 3300 may have a substantially constant thickness, though this limitation is not critical to the invention. It is understood that while the exemplary front cassette hook 3300 may be made from metal, this is not intended to limit the invention as the exemplary front cassette hook 3300 may be made from other materials such as, but not limited to, plastic. Regardless, in example embodiments the thickness TFCH of the front cassette hook 3300 may be about the same size as, or smaller than the height FHH of the spacers 3220.

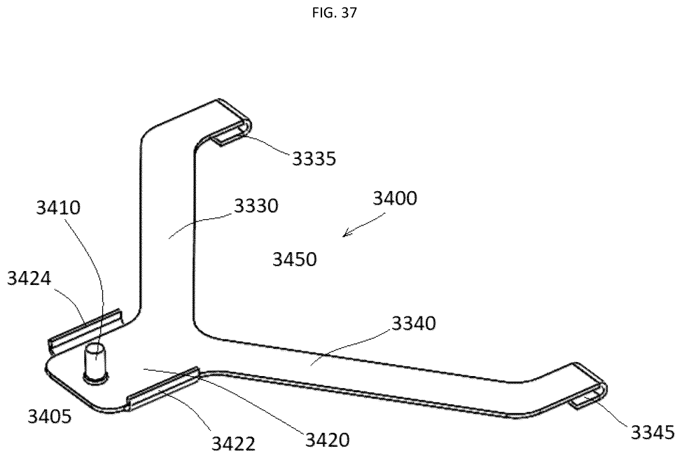

FIG. 37 is a perspective view of an exemplary rear cassette hook 3400. As shown in FIG. 37, the exemplary rear cassette hook 3400 may include a first end 3405 and a second end 3450. The first end 3405 of the exemplary rear cassette hook 3400 may have a body 3420 which may resemble a substantially flat plate from which the protrusion 3410 may extend. Though not shown in the figures it is understood the protrusion 3410 may have threads configured to engage threads of the securing member 3500 when the securing member 3500 is configured as a nut. At the sides of the body 3420 are guides 3420 and 3424 which may engage the spacers 3220 and 3222 of the frame hook 3200. The guides 3420 and 3424 may help center the engagement plate 3218 of the frame hook 3200 on the body 3420 of the exemplary rear cassette hook 3400 and/or may help prevent the frame hook 3200 from pivoting with respect to the rear cassette hook 3400. Extending from the body 3420 is a first arm 3330 and a second arm 3340 which, when viewed from the top, may form a 90 degree angle. However, this angle is merely for purposes of illustration only since the angle may form an angle greater than 90 degrees or less than 90 degrees. In example embodiments, an end 3335 of the first arm 3330 may be formed as a hook shape. Similarly, an end 3345 of the second arm 3340 may also form a hook shape. In use, the ends 3335 and 3345 may be formed to receive a roof of a lottery ticket dispenser.

When the dispenser security bracket 3000 is assembled the curved end 3212 of the frame hook 3200 is inserted into the slot 3122 of the cam 3100, the front cassette hook 3300 is on the body 3420 of the rear cassette hook 3400 such that the protrusion 3410 of the rear cassette hook 3400 extends through the slot 3320 of the front cassette hook 3300 and the engagement plate 3218 of the frame hook 3200 is on the cassette hook 3300 such that the protrusion 3410 extends through the slot 3220 of the frame hook 3200. In example embodiments the frame hook 3200, front cassette hook 3300, and rear cassette hook 3400 may be fixed relative to one another by attaching the securing member 3500 to the protrusion 3410. For example, when the securing member 3500 is a nut, the nut may be turned onto the protrusion 3410 until the nut presses against the frame hook 3200 with enough force to frictionally bind the frame hook 3200, front cassette hook 3300, and rear cassette hook 3400 together.

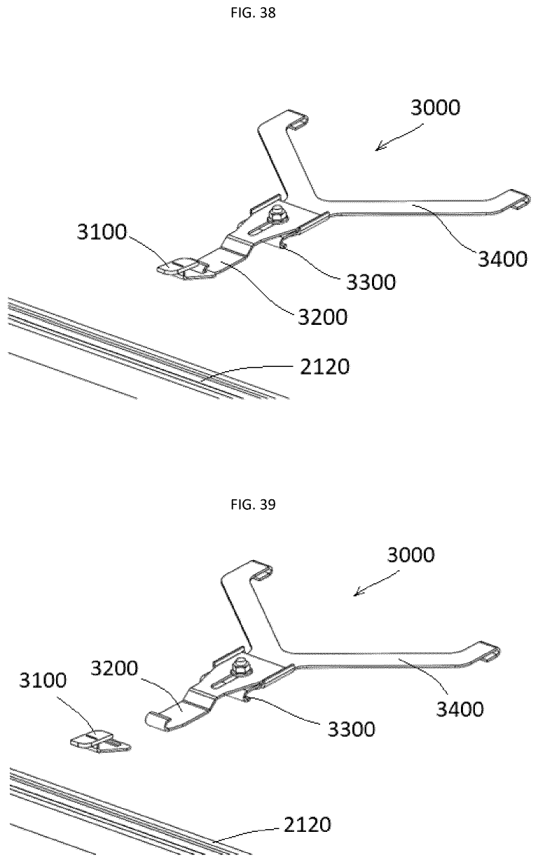

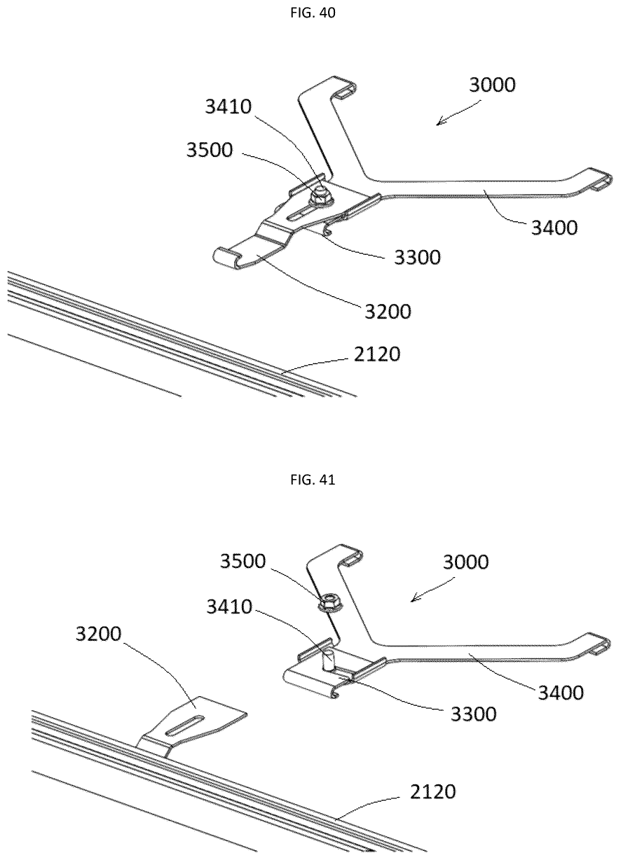

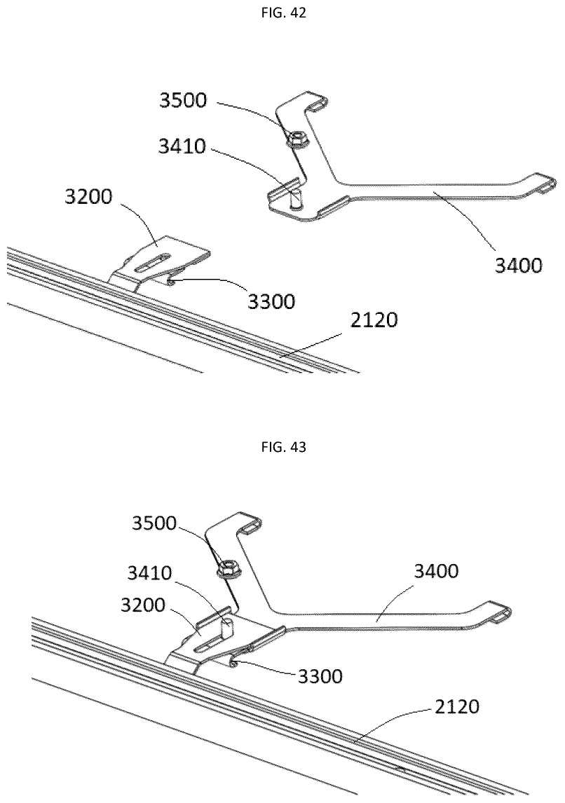

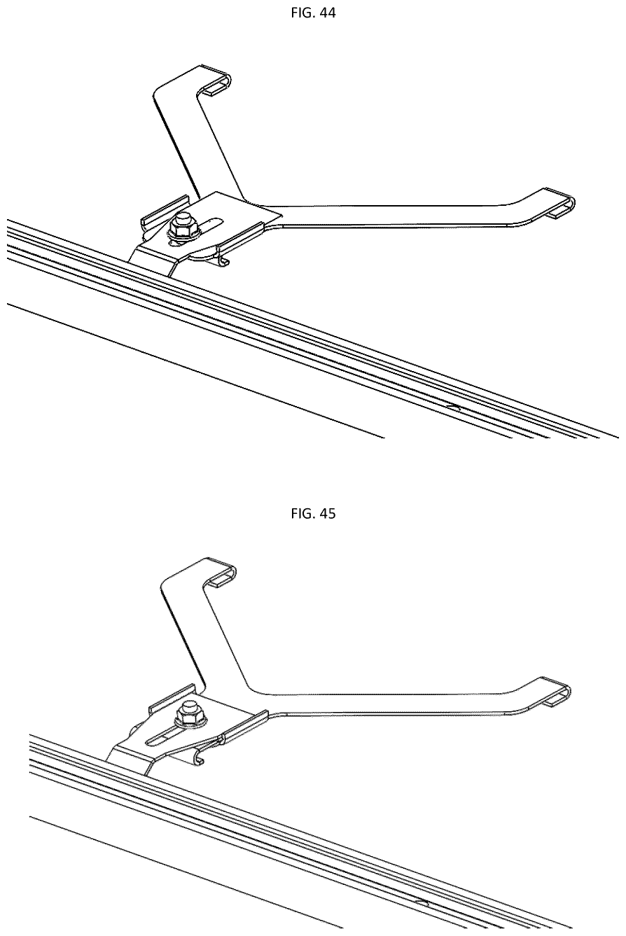

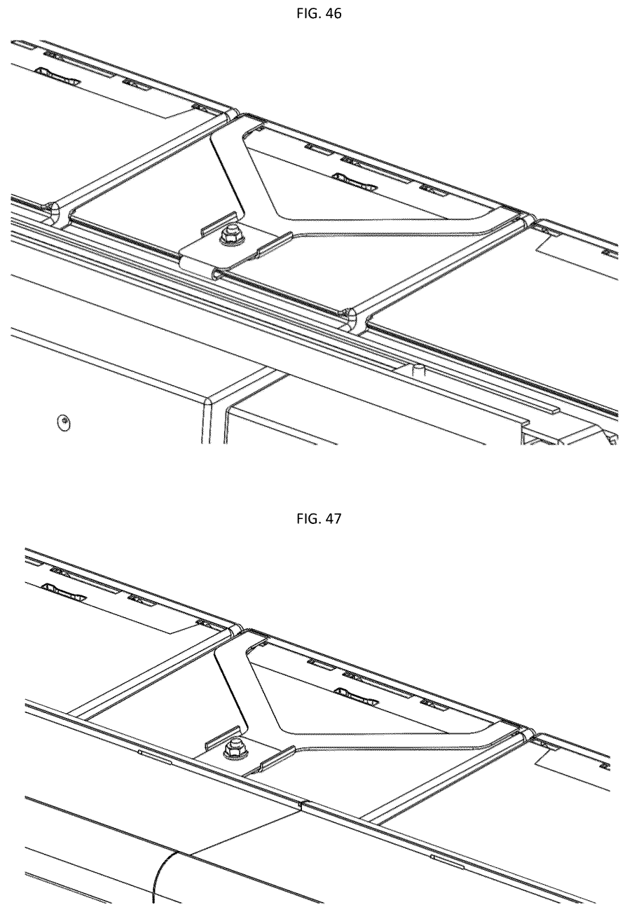

FIGS. 38-43 show various operations for attaching the dispenser security bracket 3000 to a top 2120 of the frame 2100. These operations are exemplary only and are not intended to limit the invention. As shown in FIGS. 38-43 the dispenser security bracket 3000 may be arranged near the top 2120 of the frame 2100. The cam 3100 may be removed and installed under the top 2120 of the frame as described earlier. The securing member 3500 may then be removed allowing the dispensing security bracket 3000 to be disassembled. With the securing member 3500 removed the frame hook 3200 may be removed and attached to the cam 3100 as shown in FIG. 42. The front cassette hook 3300 may be arranged under the frame hook 3200 as also shown in FIG. 42 and the rear cassette hook 3400 may then be moved so that its protrusion 3410 penetrates the slot 3320 of the front cassette hook 3300 and the slot 3220 of the frame hook 3200 as shown in FIG. 43. The securing member 3500 may then engage the protrusion 3410 of the rear cassette hook 3400 to connect the frame hook 3200, the front cassette hook 3300, and the rear cassette hook 3400 together. Because of the slot 3220 of the frame hook 3200, each of the front cassette hook 3330 and rear cassette hook 3400 may have their positions adjusted relative to the frame hook 3200. FIG. 44, for example, shows the front and rear cassette hooks 3300 and 3400 arranged near the front side of the frame hook 3200 whereas FIG. 45 shows the front and rear cassette hooks 3300 and 3400 arranged near the back side of the frame hook 3200. FIG. 46 shows the dispenser security bracket 3000 attached to the top 2120 of the frame 2100 while also connecting to a roof of a lottery ticket dispenser (noting one end of the roof of the lottery ticket dispenser in inserted into the ends 3335 and 3345 of the rear cassette hook 3400 and another end of the roof is partially inserted into the curved end 3312 of the front cassette hook 3300). FIG. 47 shows the same with the modular frame included.

As one skilled in the art would readily appreciate, the modular frame 1000 of example embodiments may assembled without the use of tools. Additionally, connectors 1600 may be used to attach the modular frame 1000 to a plurality of lottery ticket dispensers 100 by using the hooks of the connectors 1600 to capture sidewalls of one or more lottery ticket dispensers of the plurality of lottery ticket dispensers 100. As such, not only can the modular frame 1000 be constructed without the use of tools, but the modular frame 1000 can also attach to a plurality of lottery ticket dispensers 100 without the use of tools. Further, a security frame 2000 with a dispenser security bracket 3000 can be constructed to add security to the modular frame 1000 and the plurality of lottery ticket dispensers 100 without the use of tools. As such, in one nonlimiting example embodiment, a plurality of interconnected lottery ticket dispensers 100 may be attached to the modular frame 1000 without the use of tools via the connectors 1600 which attach to walls of some of the lottery ticket dispensers of the plurality of lottery ticket dispensers 100 while the security bracket 300 attaches to a roof of one of the lottery ticket dispensers 100, again, without the use of tools, to create a substantially secure and interlocked structure.

What is claimed:

1. A modular frame for a plurality of lottery ticket dispensers, the modular frame comprising:
a top above the plurality of lottery ticket dispensers;
a bottom below the plurality of lottery ticket dispensers;
a first side on a first side of the plurality of lottery ticket dispensers; and
a second side on a second side of the plurality of lottery ticket dispensers, wherein the top, bottom, first side and second side of the modular frame form a rectangular ring around the plurality of lottery ticket dispensers and the top and bottom include lights to illuminate the plurality of lottery ticket dispensers.

2. The modular frame of claim 1, wherein
the top is comprised of a plurality of interconnected upper units;
the bottom is comprised of a plurality of interconnected base units;
the first side is comprised of a first plurality of interconnected side units;
the second side is comprised of a second plurality of interconnected side units.

3. The modular frame of claim 2, wherein
the upper units of the plurality of interconnected upper units are substantially identical,
the bottom units of the plurality of interconnected bottom units are substantially identical, and
the side units of the pluralities of interconnected side units are substantially identical.

4. The modular frame of claim 2, wherein
each upper unit of the plurality of interconnected upper units has a connector inserted into a receiving area of another upper unit of the plurality of interconnected upper units,
each bottom unit of the plurality of interconnected bottom units has a connector inserted into a receiving area of another base unit of the plurality of interconnected base units, and
each side unit of the pluralities of interconnected side units has a connector inserted into a receiving area of another side unit of the plurality of interconnected side units.

5. The modular frame of claim 2, wherein
each upper unit of the plurality of interconnected upper units includes a first connector and a first receiving area on a first side of the upper unit and a second connector and a second receiving area on a second side of the upper unit.

6. The modular frame of claim 5, wherein
the first connector is comprised of a pair of substantially rigid members and a pair of substantially resilient members configured to insert into a receiving area of another upper unit.

7. The modular frame of claim 2, wherein
each side unit of the pluralities of interconnected side units includes a first connector and a first receiving area on a first side of the side unit and a second connector and a second receiving area on a second side of the side unit.

8. The modular frame of claim 7, wherein
the first connector is comprised of a pair of substantially rigid members and a pair of substantially resilient members configured to insert into a receiving area of another side unit.

9. The modular frame of claim 1, wherein
the top includes lights to illuminate the plurality of lottery ticket dispensers; and
the first and second sides include lights to illuminate the plurality of lottery ticket dispensers.

10. The modular frame of claim 1, further comprising:
at least one connector connecting the modular frame to the plurality of lottery ticket dispensers.

11. The modular frame of claim 10, wherein the at least one connector connects one of the first side and the second side to the plurality of lottery ticket dispensers.

12. The modular frame of claim 1, further comprising:
an antitheft frame comprising a top, a first leg attached to the top of the antitheft frame, a second leg attached to the top of the antitheft frame, a first reach around shield attached to the first leg, and a second reach around shield attached to the second leg.

13. The modular frame of claim 12, wherein
the top of the antitheft frame is substantially horizontal,
the first leg is substantially vertical, and
the second leg is substantially vertical.

14. The modular frame of claim 12, wherein the first leg includes a first counterfixing to fix the first leg to a counter and the second leg includes a second counter fixing to fix the second leg to the counter.

15. The modular frame of claim 12, wherein the antitheft frame further includes a dispenser security bracket extending from the top of the antitheft frame over the plurality of lottery tickets.

16. A modular frame for a plurality of lottery ticket dispensers, the modular frame comprising:
a plurality of interconnected top units forming a top of the modular frame;
a plurality of interconnected base units forming a base of the modular frame;
a first plurality of interconnected side units forming a first side of the modular frame; and
a second plurality of interconnected side units forming a second side of the modular frame, wherein the top is a substantially horizontal structure, the bottom is a substantially horizontal structure, and the first and second sides are substantially vertical structures.

17. The modular frame of claim 16 further comprising:
lights in the top.

18. The modular frame of claim 16 further comprising:
lights in the sides.

19. The modular frame of claim 16, wherein
the plurality of interconnected top units includes at least two identical interconnected top units each having two connectors and two receiving areas; and
the first plurality of interconnected side units includes at least two identical interconnected side units each having two connectors and two receiving areas.

20. The modular frame of claim 16, further comprising:
an antitheft frame comprising a top, a first leg attached to the top of the antitheft frame, a second leg attached to the top of the antitheft frame, a first reach around shield attached to the first leg, and a second reach around shield attached to the second leg of the modular frame.
